(19) United States
(12) Patent Application Publication
(10) Pub. No.: US 2026/0170623 A1
(43) Pub. Date: Jun. 18, 2026

(54) APPARATUS, SYSTEM, AND METHOD FOR VIRTUALIZING PHYSICAL OBJECTS

(71) Applicant: HOSSEIN ZABIHI KHEIBARI, TEHRAN (IR)

(72) Inventor: HOSSEIN ZABIHI KHEIBARI, TEHRAN (IR)

(21) Appl. No.: 19/388,700

(22) Filed: Nov. 13, 2025

Related U.S. Application Data
(63) Continuation-in-part of application No. PCT/IB2023/054958, filed on May 14, 2023.

(51) Int. Cl. G06T 5/80; G06T 7/73; H04N 23/58

(52) U.S. Cl. CPC G06T 5/80; G06T 7/73; H04N 23/58; G06T 2207/10016

(57) ABSTRACT

In accordance with some embodiments herein, an apparatus is provided. The apparatus includes a UE stand including a front surface and a back surface, a mirror, and a set of support structures. The mirror is exposed by a first opening defined in the front surface. The set of structures are configured to support a UE in a target position adjacent the front surface. In some examples, the mirror is tilted at a first angle relative to a vertical axis and a second angle relative to a lateral axis to redirect a field of view of a camera of the UE to a region under the UE stand. In some examples, the vertical axis extends through a top side and a bottom side of the UE stand. In some examples, the lateral axis extends through a first lateral side and a second lateral side of the UE stand.

### RELATED APPLICATION

This application claims priority to and is a continuation-in-part of International Application Number PCT/IB2023/054958, filed on May 14, 2023, entitled “SYSTEM FOR VIRTUALIZING PHYSICAL OBJECTS”, which is incorporated herein by reference in its entirety.

### BACKGROUND

User equipment (UE) such as tablets, phones, and/or other computing devices may be used to execute interactive programs including games, educational tools, and other applications. In some implementations, accessories or support structures may enhance the functionality of such devices by enabling new modes of interaction or imaging.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A illustrates a perspective view of an apparatus showing a front surface of a UE stand, in accordance with some embodiments.

FIG. 1B illustrates a perspective view of an apparatus showing a back surface of a UE stand, in accordance with some embodiments.

FIG. 1C illustrates a cross-sectional view of a UE stand of an apparatus, in accordance with some embodiments.

FIG. 1D illustrates a first support structure of an apparatus in a first position, in accordance with some embodiments.

FIG. 1E illustrates an exploded view of an apparatus, in accordance with some embodiments.

FIGS. 2A-2B illustrate a first scenario in which an apparatus receives and/or supports a first type of UE in a first target position, in accordance with some embodiments.

FIGS. 3A-3C illustrate a second scenario in which an apparatus receives and/or supports a second type of UE in a second target position, in accordance with some embodiments.

FIGS. 4A-4E illustrate aspects of a system comprising an apparatus and a landmark pad, in accordance with some embodiments.

FIG. 5 illustrates a flow chart of a method for holding a UE and/or utilizing a UE to virtualize physical objects, in accordance with some embodiments.

FIGS. 6A-6E illustrate various scenarios in which an apparatus, a UE, and/or a system is used to virtualize physical objects and/or interact with a user, in accordance with some embodiments.

FIG. 7 illustrates a data structure indicative of exemplary features of various exemplary application elements executed by an interactive application, in accordance with some embodiments.

FIG. 8 illustrates an exemplary computing environment in which one or more of the provisions set forth herein may be implemented.

FIG. 9 illustrates an exemplary computer-readable medium comprising processor-executable instructions, wherein the processor executable instructions may be configured to embody one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative.

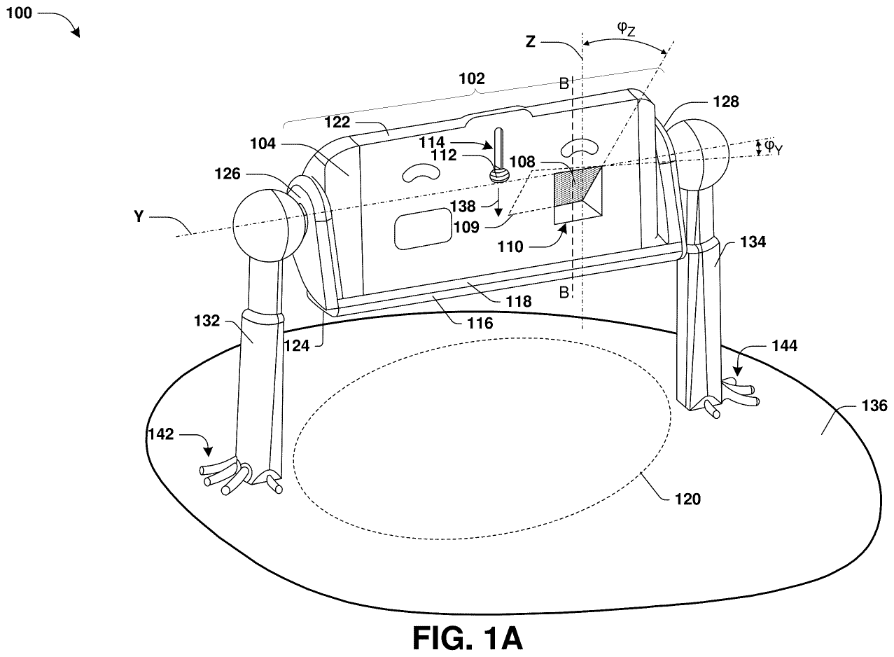

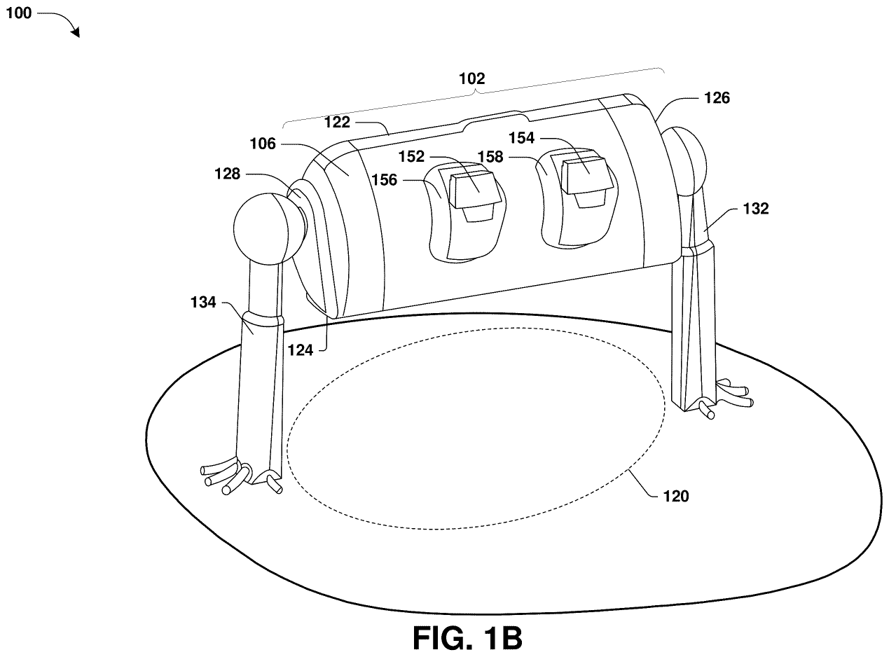

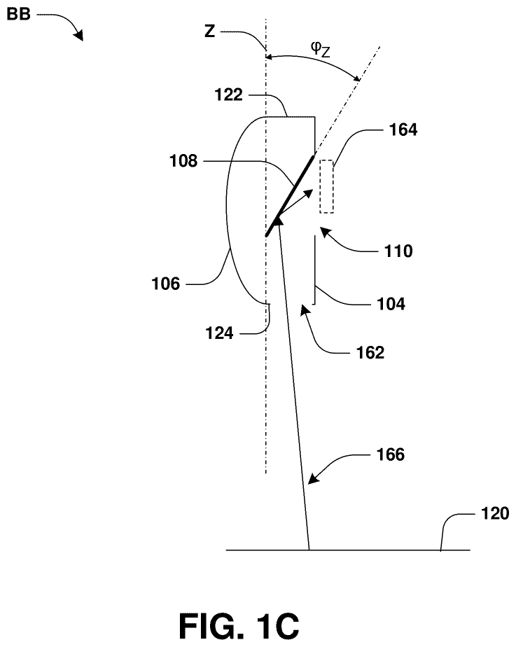

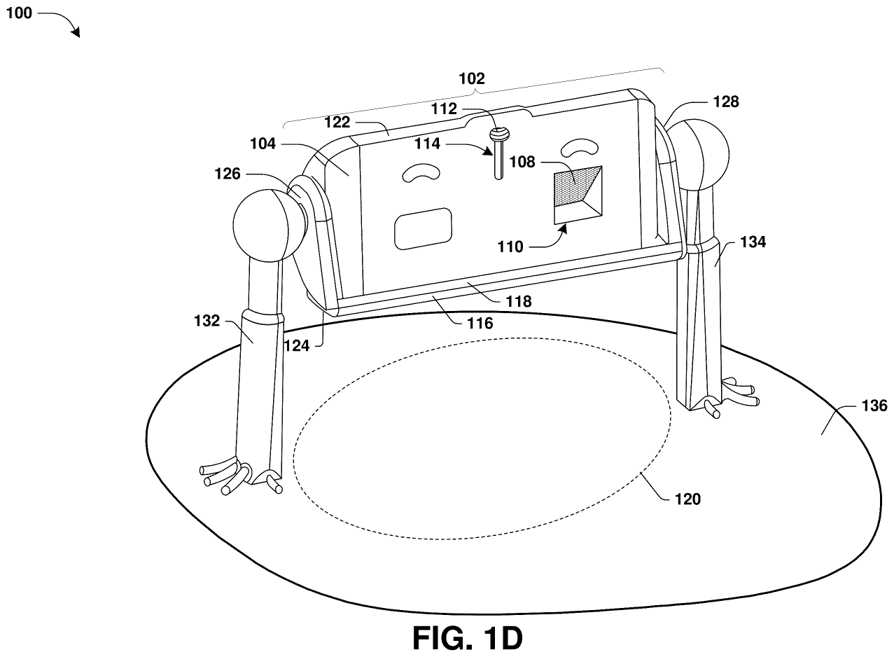

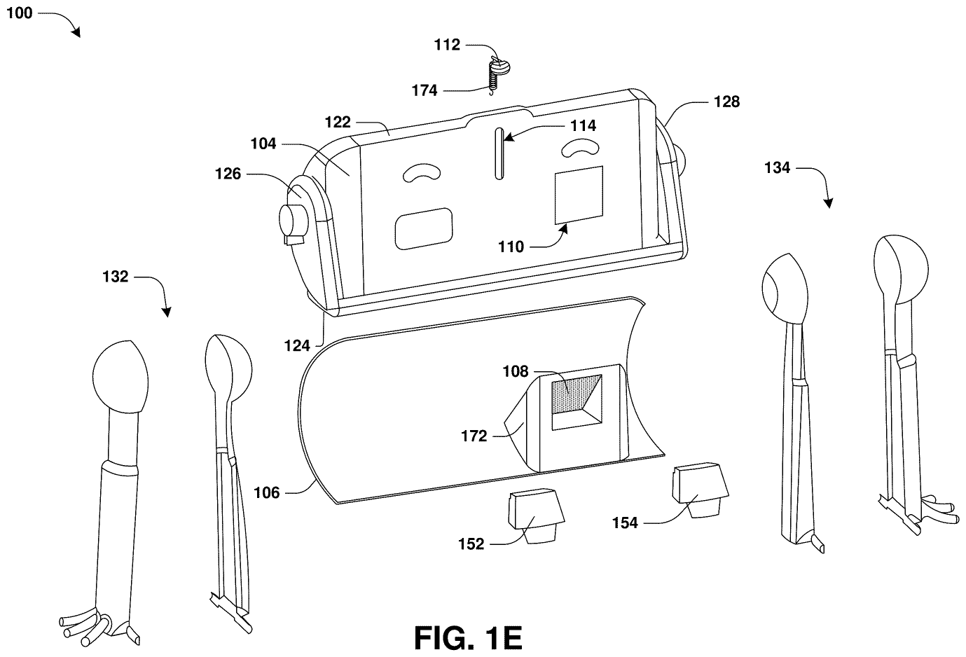

The present disclosure relates to apparatuses, systems, and methods for holding a User Equipment (UE) and/or utilizing the UE to virtualize physical objects and/or perform other tasks. FIGS. 1A-1E illustrate aspects of an apparatus 100 for supporting a UE, in accordance with some embodiments. In some examples, the apparatus 100 may comprise a UE stand 102 comprising a front surface 104 and/or a back surface 106. FIG. 1A illustrates a perspective view of the apparatus 100 showing the front surface 104 of the UE stand 102, in accordance with some embodiments. The UE stand 102 may comprise a mirror 108 between the front surface 104 and the back surface 106. The mirror 108 may be exposed by a first opening 110 defined by the front surface 104. An outline of a portion, of the mirror 108, that is covered by the front surface 104 of the UE stand 102 is shown with dashed-line 109 in FIG. 1A.

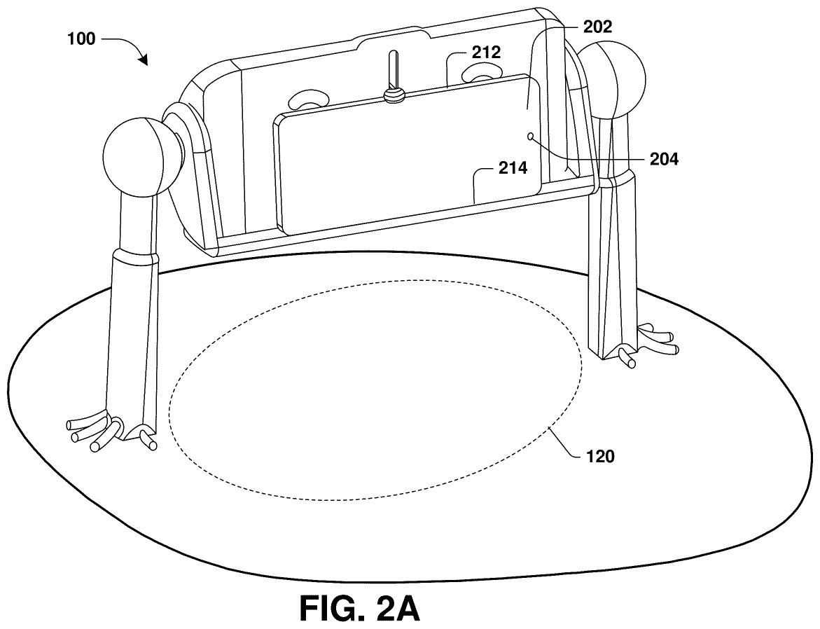

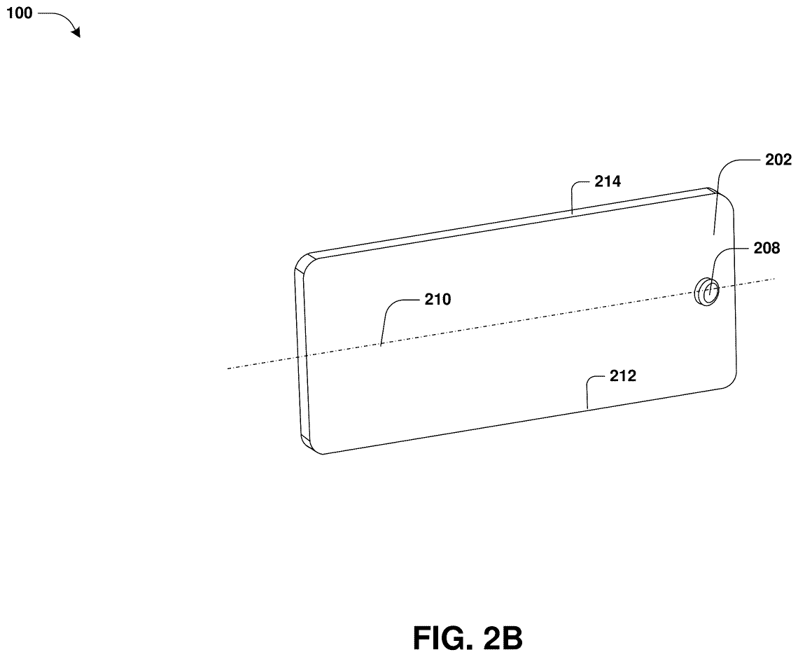

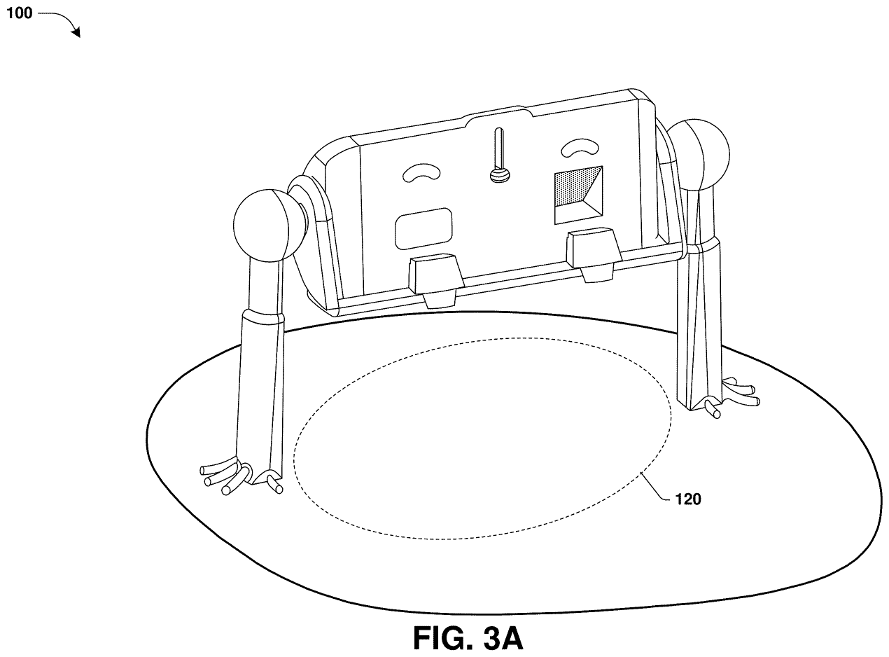

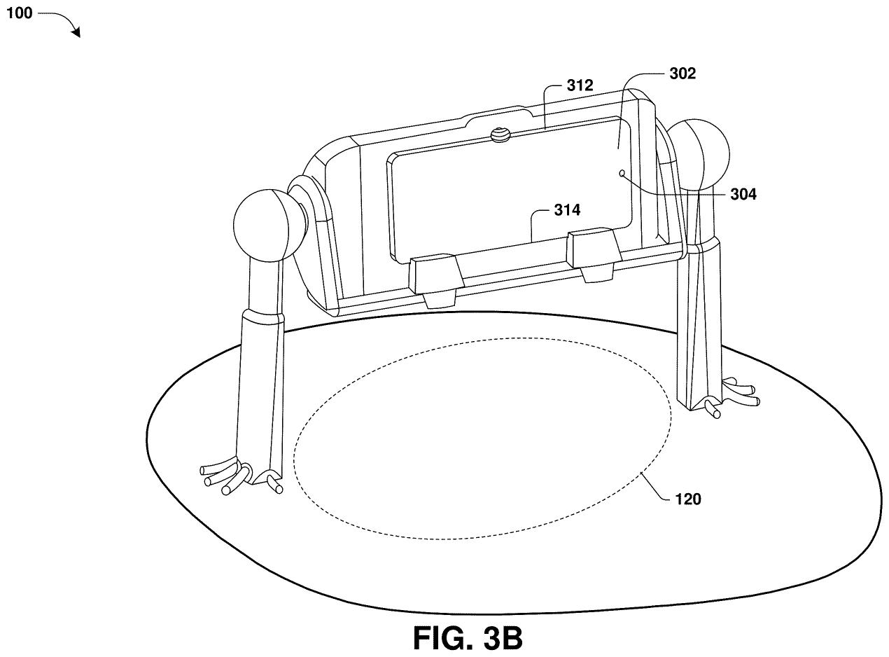

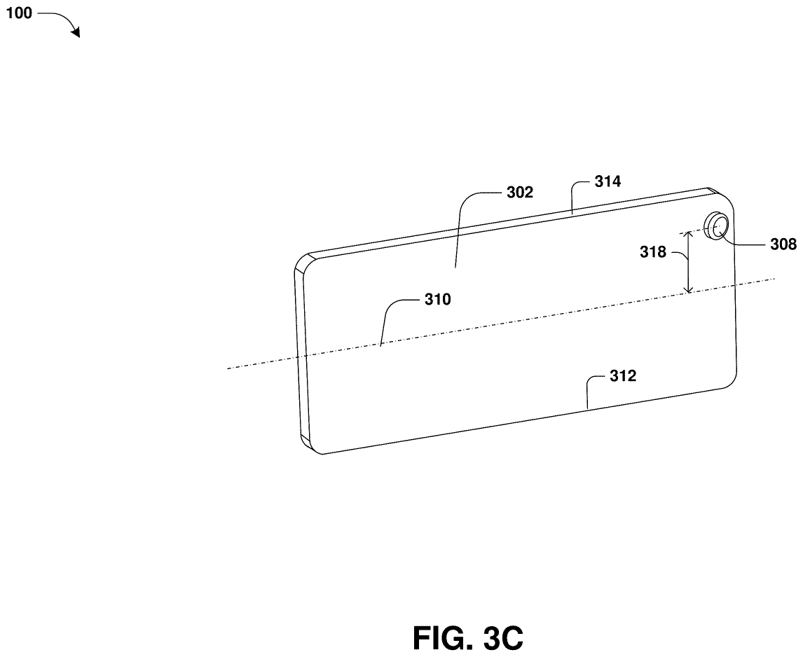

In some examples, the UE stand 102 may comprise a set of support structures (e.g., a set of one or more support structures) configured to support a UE in a target position adjacent the front surface 104, for example, a first target position shown in FIG. 2A and/or a second target position shown in FIG. 3B. The set of support structures may comprise a first support structure 112 (e.g., a tab) protruding from the front surface 104. The first support structure 112 may be proximal a top side 122 of the UE stand 102 and/or distal a bottom side 124 of the UE stand 102. The first support structure 112 may be configured to engage a first side of a UE (e.g., a first side 212 of a first UE 202 shown in FIG. 2A and/or a first side 312 of a second UE 302 shown in FIG. 3B).

In some examples, the first support structure 112 may protrude through a second opening 114 defined in the front surface 104. The first support structure 112 may be moveable between a first position (e.g., an upper position) relative to the second opening 114 and a second position (e.g., a lower position) relative to the second opening 114. The first position of the first support structure 112 may be closer to the top side 122 of the UE stand 102 than the second position. FIG. 1A depicts the first support structure 112 in the second position, in accordance with some embodiments. FIG. 1D depicts the first support structure 112 in the first position, in accordance with some embodiments.

In some examples, the apparatus 100 may comprise a biasing component 174 (shown in FIG. 1E) configured to bias the first support structure 112 to the second position (e.g., the lower position), such as by applying a biasing force to the first support structure 112 in a (downwards) direction 138 (shown in FIG. 1A). The biasing component 174 may be between the front surface 104 and the back surface 106. The biasing component 174 may comprise a spring with a first end (e.g., top end) coupled to the first support structure 112 and/or a second end (e.g., bottom end) coupled to a component (e.g., a static component that is between the front surface 104 and the back surface 106 and/or under the second position of the first support structure 112) of the UE stand 102. In some examples, the first support structure 112 is moved from the second position (e.g., the lower position) to the first position (e.g., the upper position) by lifting (using a finger or an edge of a UE, for example) the first support structure 112 with a lifting force that overcomes the biasing force applied by the biasing component 174.

The set of support structures may comprise a second support structure 116 (e.g., a lip and/or protruding edge) protruding from the front surface 104. The second support structure 116 may be proximal the bottom side 124 of the UE stand 102 and/or distal the top side 122 of the UE stand 102. For example, the second support structure 116 may be located at or near the bottom side 124 of the UE stand 102. In some examples, the second support structure 116 may be configured to engage a second side of the UE (e.g., a second side 214 of the first UE 202 shown in FIG. 2A) and/or an adaptor (e.g., at least one of a first detachable adaptor 152 or a second detachable adaptor 154 shown in FIG. 1E). For example, the second support structure 116 may comprise a surface 118 upon which the second side of the UE and/or the adaptor rests.

FIG. 1B illustrates a perspective view of the apparatus 100 showing the back surface 106 of the UE stand 102, in accordance with some embodiments. In some examples, at least a portion of the back surface 106 may be curved. In some examples, the apparatus 100 may comprise a set of detachable adaptors (e.g., a set of one or more detachable adaptors). The set of detachable adaptors may comprise the first detachable adaptor 152 and/or the second detachable adaptor 154. In some examples, the set of detachable adaptors may be detachably mounted to a set of adaptor holders (e.g., a set of one or more adaptor holders). The set of adaptor holders may be coupled to and/or may protrude from the back surface 106 of the UE stand 102. The set of adaptor holders may comprise a first adaptor holder 156 (shown in FIG. 1D) and/or a second adaptor holder 158. In some examples, the first adaptor holder 156 and/or the second adaptor holder 158 may hold the first detachable adaptor 152 and/or the second detachable adaptor 154, respectively, when the first detachable adaptor 152 and/or the second detachable adaptor 154 are not in use to support a UE in a target position. In some examples, the first detachable adaptor 152 and/or the second detachable adaptor 154 may be mountable to the second support structure 116. The first detachable adaptor 152 and/or the second detachable adaptor 154 may be configured to engage a second side of a UE (e.g., a second side 314 of the second UE 302 shown in FIG. 3B) to support the UE in a target position (e.g., the second target position shown in FIG. 3B).

In some examples, the apparatus 100 may comprise a set of legs (e.g., a set of one or more legs). The set of legs may comprise a first leg 132 and/or a second leg 134. The first leg 132 may have a first side coupled (e.g., pivotally coupled) to a first lateral side 126 of the UE stand 102, and/or a second side configured to engage a support surface 136 (on which the apparatus 100 is placed, for example). In some examples, the support surface 136 may comprise a table, desk, a floor and/or ground, a counter, a wall, a whiteboard, a chalkboard, a customized surface, and/or other type of surface. The second side of the first leg 132 may comprise a first set of fingers 142 (e.g., a set of one or more fingers), protruding from the first leg 132, configured to engage the support surface 136 and/or to support and/or stabilize a position of the apparatus 100. The second leg 134 may have a first side coupled (e.g., pivotally coupled) to a second lateral side 128 of the UE stand 102, and/or a second side configured to engage a support surface 136 (on which the apparatus 100 is placed, for example). The second side of the second leg 134 may comprise a second set of fingers 144 (e.g., a set of one or more fingers), protruding from the second leg 134, configured to engage the support surface 136 and/or to support and/or stabilize the position of the apparatus 100.

In some examples, the mirror 108 may be tilted at a first angle φ_{Z} relative to a vertical axis Z (shown in FIGS. 1A and 1C). The vertical axis Z may extend through the top side 122 and the bottom side 124 of the UE stand 102. The first angle φ_{Z} may be between about 20 degrees to about 45 degrees, between about 25 degrees to about 40 degrees, between about 31 degrees to about 35 degrees, between about 33 degrees to about 34 degrees, and/or about 33.18 degrees.

The mirror 108 may be tilted at a second angle φ_{Y} relative to a lateral axis Y (shown in FIG. 1A). The lateral axis Y may extend through the first lateral side 126 and the second lateral side 128 of the UE stand 102. The second angle φ_{Y} may be between about 3 degrees to about 15 degrees, between about 5 degrees to about 9 degrees, between about 6 degrees to about 8 degrees, between about 6 degrees to about 7 degrees, and/or about 6.82 degrees.

The mirror 108 may be configured to redirect a field of view of a camera 164 (shown in FIG. 1C) to a region under the UE stand 102. The camera 164 may comprise a rear-facing camera of a UE positioned in a target position adjacent the front surface 104. The camera 164 may comprise a rear-facing camera 208 (shown in FIG. 2B) of the first UE 202. Alternatively and/or additionally, the camera 164 may comprise a rear-facing camera 308 (shown in FIG. 3C) of the second UE 302. In some examples, the region, to which the field of view of the camera 164 is redirected, may comprise a region 120 between the first leg 132 and the second leg 134. FIG. 1C illustrates a cross-sectional view, of the UE stand 102, taken across line B-B shown in FIG. 1A. In some examples, light 166 may be reflected from the region 120, through an opening 162 defined in the bottom side 124 of the UE stand 102, towards the mirror 108. The mirror 108 may reflect the light 166 to the camera 164.

FIG. 1E illustrates an exploded view of the apparatus 100, in accordance with some embodiments. In some examples, the mirror 108 may be supported in a position (e.g., adjacent the first opening 110 of the front surface 104) relative to the back surface 106 and/or the front surface 104 using a mirror holder 172, which may be coupled to the back surface 106. In some examples, the mirror 108 may comprise a flat mirror, a curved mirror, a split mirror, and/or other type of mirror. In some examples, the mirror 108 may be moveable within the mirror holder 172, for example, to adjust at the first angle φ_{Z} and/or the second angle φ_{Y}.

FIGS. 2A-2B illustrate a first scenario in which the apparatus 100 receives and/or supports a first type of UE in the first target position, in accordance with some embodiments. FIG. 2A illustrates the first UE 202 supported in the first target position, in accordance with some embodiments. In some examples, the first UE 202 may comprise a smartphone, a tablet, and/or other suitable device (e.g., a device with a rear-facing camera, for example). FIG. 2B illustrates the first UE 202, in accordance with some embodiments. UEs of the first type of UE, such as the first UE 202 shown in FIG. 2B, may be mounted to and/or supported by the UE stand 102 without use of the set of detachable adaptors. The first type of UE may correspond to a UE with a rear-facing camera that is centered between lateral sides of the UE or offset from a centerline between the lateral sides of the UE by a distance that is less than a threshold distance. For example, the rear-facing camera 208 of the first UE 202 may be at a centerline 210 between lateral sides 212 and 214 of the first UE 202, or may be offset from the centerline 210 by a distance that is less than the threshold distance.

In some examples, the first support structure 112 may engage the first side 212 of the first UE 202. For example, the first support structure 112 may be in contact with the first side 212 of the first UE 202 and/or may apply a UE holding force to the first side 212 of the first UE 202 (to push the first UE 202 against the surface 118 of the second support structure 116, for example). For example, the UE holding force may be applied by way of the biasing component 174 applying the biasing force in the (downwards) direction 138 (shown in FIG. 1A). The first UE 202 may thus be held (in the first target position) between the first support structure 112 and the second support structure 116. In some examples, at least a portion of the first support structure 112 may hang over a front surface of the first UE 202 to inhibit frontwards motion of the first UE 202 (to prevent the first UE 202 from tipping over and/or falling off the UE stand 102, for example).

FIGS. 3A-3C illustrate a second scenario in which the apparatus 100 receives and/or supports a second type of UE in the second target position, in accordance with some embodiments. FIG. 3A illustrates the first detachable adaptor 152 and/or the second detachable adaptor 154 mounted to the second support structure 116, in accordance with some embodiments. For example, the first detachable adaptor 152 and/or the second detachable adaptor 154 may be in contact with the surface 118 of the second support structure 116. FIG. 3B illustrates the second UE 302 supported in the second target position, in accordance with some embodiments. In some examples, the second UE 302 may comprise a smartphone, a tablet, and/or other suitable device (e.g., a device with a rear-facing camera, for example). The first detachable adaptor 152 and/or the second detachable adaptor 154 may be between the second UE 302 (in the second target position) and the second support structure 116.

FIG. 3C illustrates the second UE 302, in accordance with some embodiments. UEs of the second type of UE, such as the second UE 302 shown in FIG. 3C, may be mounted to and/or supported by the UE stand 102 using the set of detachable adaptors. The second type of UE may correspond to a UE with a rear-facing camera that is offset from a centerline between lateral sides of the UE by a distance greater than the threshold distance. For example, the rear-facing camera 308 of the second UE 302 may be offset from a centerline 310 between lateral sides 312 and 314 by a distance 318 that is greater than the threshold distance.

In some examples, the first support structure 112 may engage the first side 312 of the second UE 302. For example, the first support structure 112 may be in contact with the first side 312 of the second UE 302 and/or may apply the UE holding force to the first side 312 of the second UE 302 (to push the second UE 302 against the surface 118 of the first detachable adaptor 152 and/or the second detachable adaptor 154, for example). For example, the UE holding force may be applied by way of the biasing component 174 applying the biasing force in the (downwards) direction 138 (shown in FIG. 1A). The second UE 302 may thus be held (in the second target position) between the first support structure 112 and the set of detachable adaptors (e.g., the first detachable adaptor 152 and/or the second detachable adaptor 154). In some examples, at least a portion of the first support structure 112 may hang over a front surface of the second UE 302 to inhibit frontwards motion of the second UE 302 (to prevent the second UE 302 from tipping over and/or falling off the UE stand 102, for example).

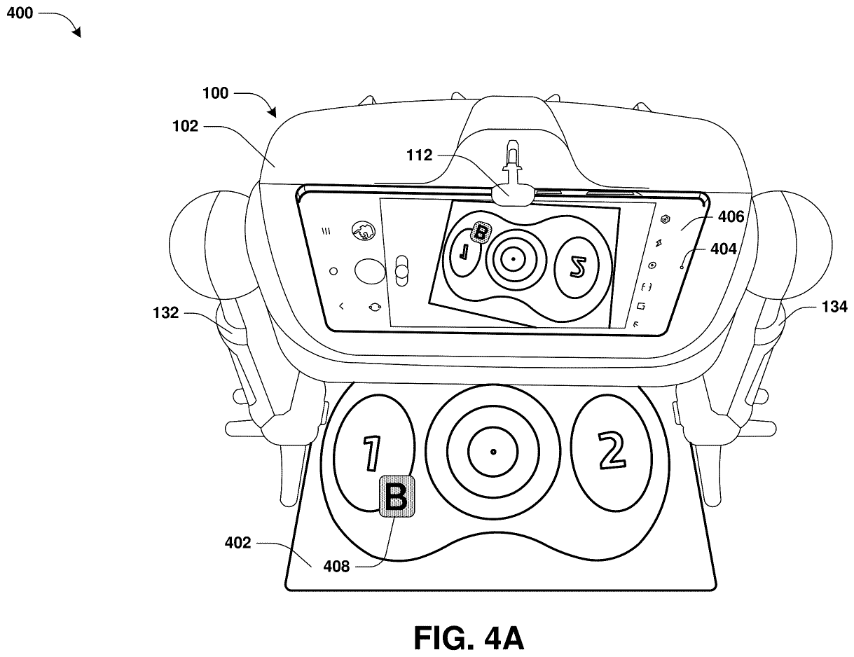

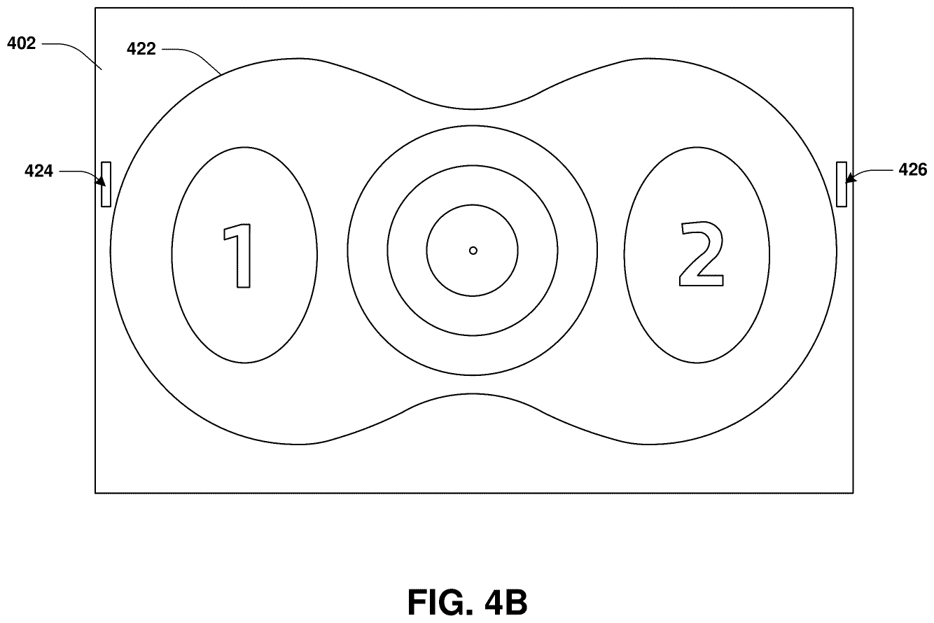

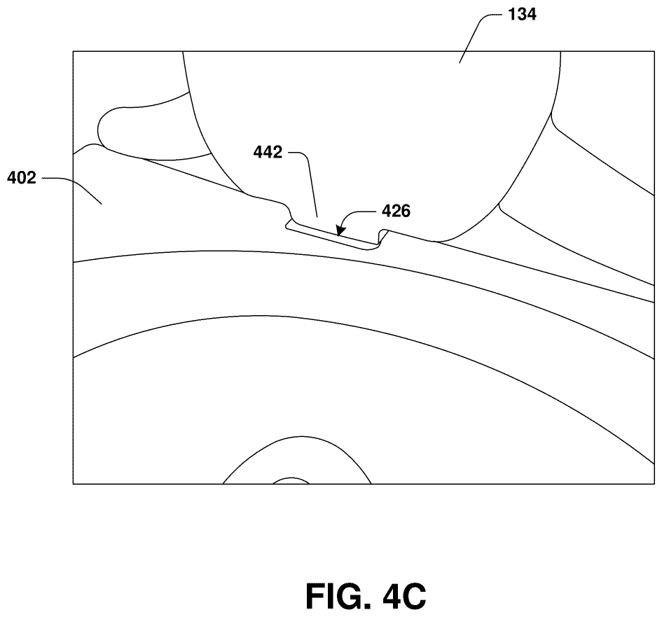

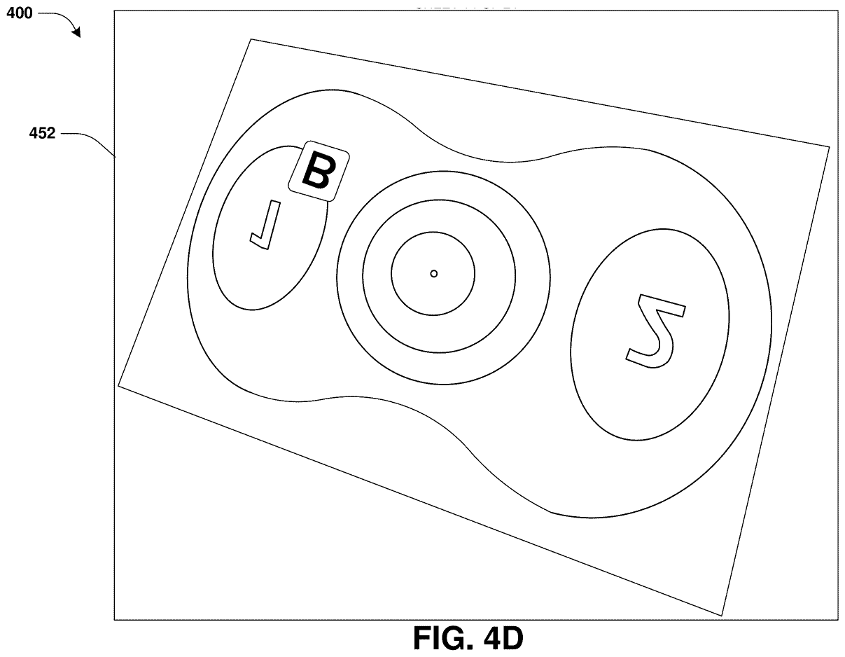

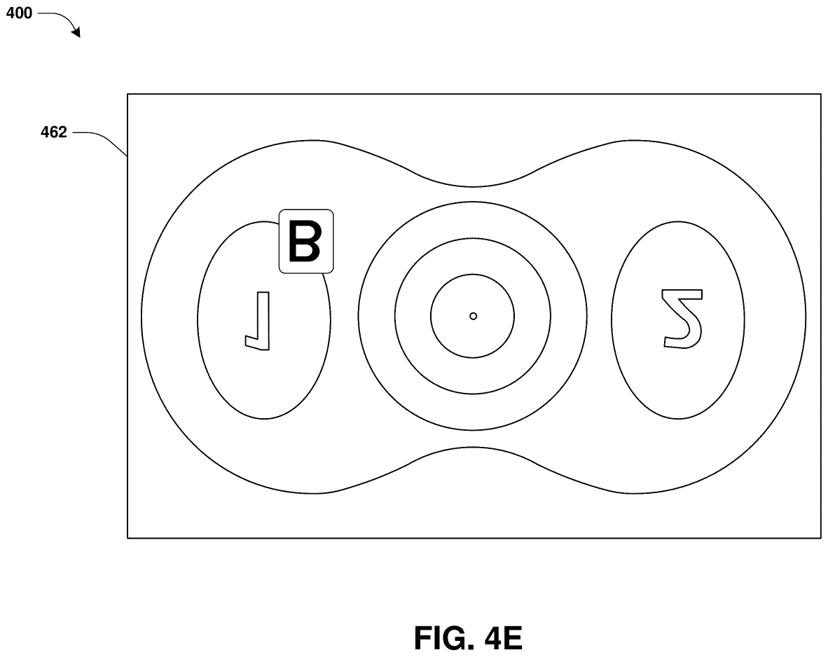

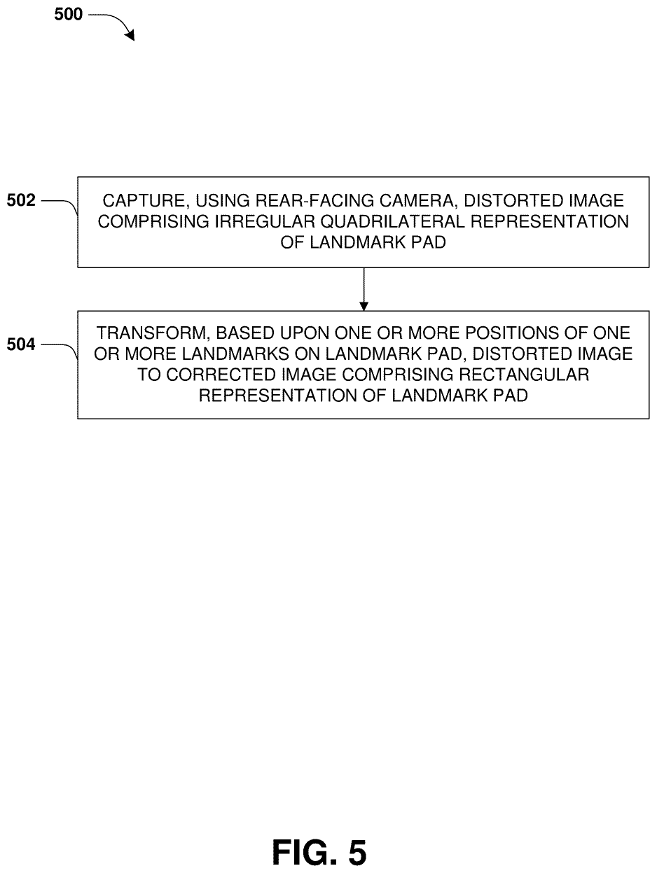

FIGS. 4A-4E illustrate aspects of a system 400 comprising the apparatus 100 and a landmark pad 402, described in conjunction with example method 500 of FIG. 5 herein, in accordance with some embodiments. FIG. 4A illustrates an overhead view of the apparatus 100 and the landmark pad 402, in accordance with some embodiments. The landmark pad 402 may be under the UE stand 102. For example, at least a portion of the landmark pad 402 may be positioned between the first leg 132 and the second leg 134. The apparatus 100 may support a UE 406 in a target position (e.g., the first UE 202 in the first target position and/or the second UE 302 in the second target position) adjacent the front surface 104 of the UE stand 102. In some examples, the UE 406 may comprise a smartphone, a tablet, and/or other suitable device (e.g., a device with a rear-facing camera, for example). The UE 406 may comprise a rear-facing camera (not shown) facing the mirror 108 and/or a front-facing camera 404. In some examples, the mirror 108 may be oriented (e.g., tilted at the first angle φ_{Z} relative to the vertical axis Z and/or the second angle φ_{Y} relative to the lateral axis Y) to redirect a field of view of the rear-facing camera to the landmark pad 402. In FIG. 4A, the UE 406 displays (on a touchscreen pf the UE 406, for example) a camera interface showing the field of view of the rear-facing camera.

FIG. 4B illustrates the landmark pad 402, in accordance with some embodiments. The landmark pad 402 may comprise a set of landmarks (e.g., a set of one or more landmarks), such as one or more circles, one or more ellipses, one or more numbers (e.g., “1” in a first ellipse and/or “2” in a second ellipse), and/or a boundary 422 having a defined shape and/or pattern surrounding the one or more circles and/or the one or more ellipses. Other shapes (e.g., rectangle, trapezoid, pentagon, hexagon, etc.) sizes, and/or locations of landmarks of the set of landmarks are within the scope of the present disclosure. The set of landmarks may be printed on and/or ingrained in a top surface of the landmark pad 402 (facing the UE stand 102, for example). In some examples, the landmark pad 402 may define a first groove 424 in a first edge of the landmark pad 402 and/or a second groove 426 in a second edge of the landmark pad 402 (opposite the first edge of the landmark pad 402). In some examples, the first groove 424 and/or the second groove 426 may be used to position and/or stabilize the landmark pad 402 under the UE stand 102.

For example, the first leg 132 may comprise a first protrusion (not shown) proximal the second side of the first leg 132 (that is in contact with the support surface 136, for example) and distal the first side of the first leg 132 (that is pivotally coupled to the UE stand 102, for example). For example, the first protrusion may be at or near the second side of the first leg 132. The first protrusion may be configured to engage the first groove 424 (such as by being positioned within the first groove 424 and/or being in contact with one or more walls defining the first groove 424).

Alternatively and/or additionally, the second leg 134 may comprise a second protrusion 442 (shown in FIG. 4C) proximal the second side of the second leg 134 (that is in contact with the support surface 136, for example) and distal the first side of the second leg 134 (that is pivotally coupled to the UE stand 102, for example). For example, the second protrusion 442 may be at or near the second side of the second leg 134. The second protrusion 442 may be configured to engage the second groove 426 (such as by being positioned within the second groove 426 and/or being in contact with one or more walls defining the second groove 426). FIG. 4C illustrates a magnified view of the second protrusion 442 of the second leg 134 engaging the second groove 426 defined in the landmark pad 402, in accordance with some embodiments. In some examples, the first protrusion and/or the second protrusion 442 engaging the first groove 424 and/or the second groove 426, respectively, may mitigate movement of the landmark pad 402 relative to the UE stand 102 (such that a position of the landmark pad 402 is stabilized, for example).

In some examples, the UE 406 may capture an image using the rear-facing camera of the UE 406. The image may comprise a representation of an object 408 (shown in FIG. 4A) over the landmark pad 402 and/or one or more representations of one or more landmarks of the set of landmarks (e.g., one, some, and/or all landmarks of the set of landmarks of the landmark pad 402). The UE 406 may determine a position of the object 408 (e.g., a token and/or other type of physical object) based upon the representation of the object 408 and/or the one or more representations of the one or more landmarks. For example, the position of the object 408 may be determined based upon a comparison of the representation of the object 408 in the image with the one or more representations of the one or more landmarks in the image, for example, by determining one or more distances between the representation of the object 408 in the image and the one or more representations of the one or more landmarks in the image. It may be appreciated that the landmark pad 402 may enable the UE 406 to determine the position of the object 408 with increased accuracy as compared with determining the position without using the landmark pad 402.

Alternatively and/or additionally, the UE 406 may determine a size of the object 408 based upon the representation of the object 408 and/or the one or more representations of the one or more landmarks. For example, the size of the object 408 may be determined based upon a comparison of the representation of the object 408 in the image with the one or more representations of the one or more landmarks in the image, for example, by determining a size of the representation of the object 408 in the image and one or more sizes of the one or more representations of the one or more landmarks in the image. It may be appreciated that the landmark pad 402 may enable the UE 406 to determine the size of the object 408 with increased accuracy as compared with determining the size without using the landmark pad 402.

At 502 of FIG. 5, the UE 406 may capture a distorted image 452 using the rear-facing camera of the UE 406. FIG. 4D illustrates the distorted image 452 captured using the rear-facing camera of the UE 406, in accordance with some embodiments. In some examples, the distorted image 452 may comprise an irregular quadrilateral representation of the landmark pad 402. For example, the distorted image 452 may be distorted (e.g., may comprise the irregular quadrilateral representation of the landmark pad 402) due, at least in part, to the mirror 108 being tilted at the first angle φ_{Z} relative to the vertical axis Z and/or the second angle φ_{Y} relative to the lateral axis Y.

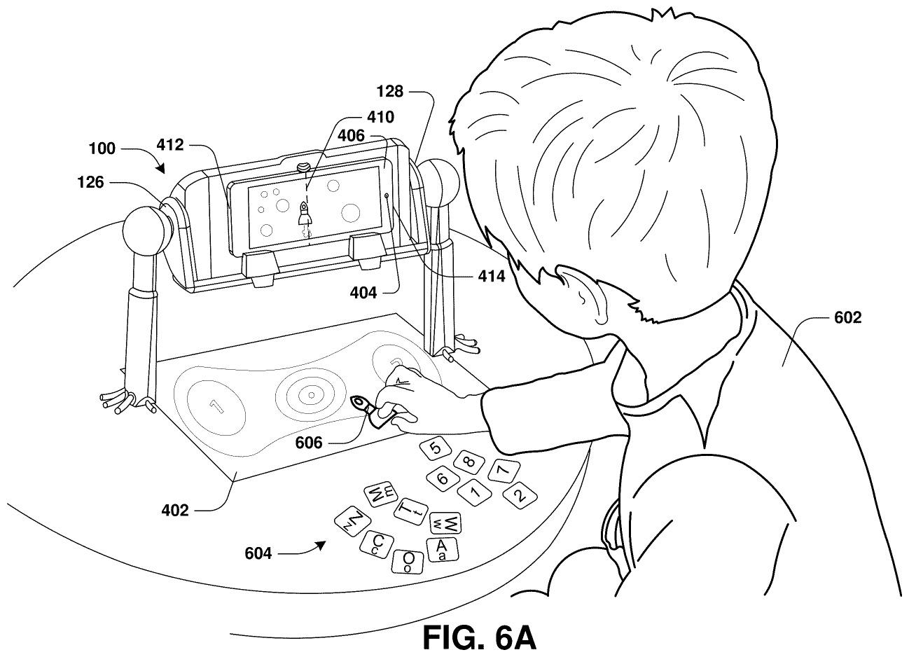

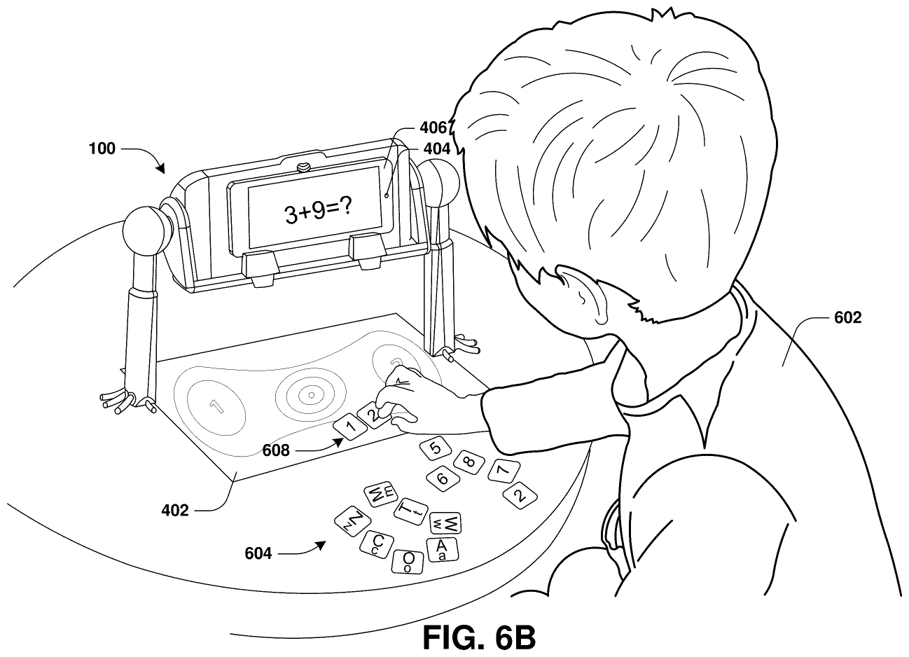

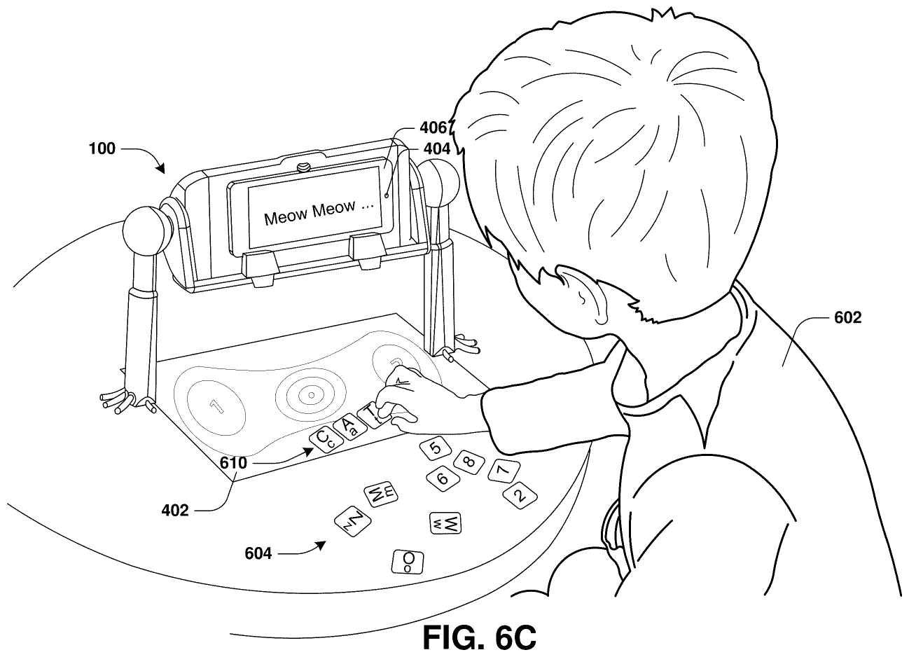

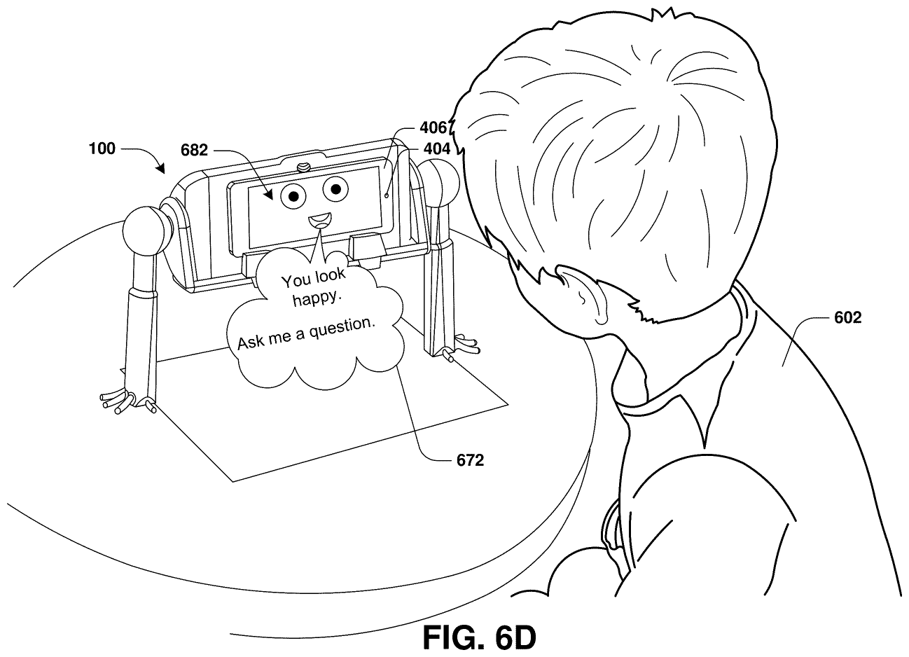

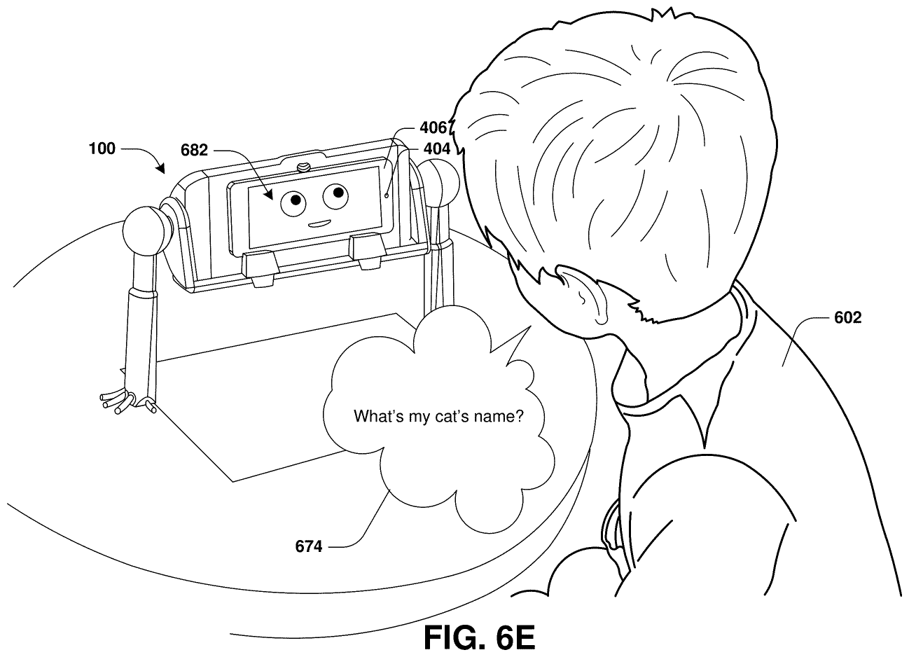

In some examples, the mirror 108 and/or the first opening 110 are positioned proximal the second lateral side 128 and distal the first lateral side 126. In some examples, the mirror 108 being tilted at the second angle φ_{Y} relative to the lateral axis Y (and/or the mirror 108 and/or the first opening 110 being positioned proximal the second lateral side 128 and distal the first lateral side 126) enables the UE 406 and/or the landmark pad 402 to be positioned in a relatively centered and/or symmetrical position relative to the UE stand 102 while the rear-facing camera is aligned with the mirror 108 and/or the first opening 110, which may provide for improved stability of the apparatus 100 and/or increased aesthetic appeal (and/or more human and/or robot-like appearance) of the apparatus 100 and/or the UE 406 (such as due, at least in part, to the UE 406, the apparatus 100, and/or the landmark pad 402 having a more symmetrical appearance as compared with apparatuses that do not tilt the mirror 108 at the second angle φ_{Y} relative to the lateral axis Y). Thus, in accordance with some embodiments, the apparatus 100 may not require that the UE 406 be placed on the UE stand 102 in an off-center and/or asymmetrical to align the rear-facing camera with the mirror 108, which may be required in some systems. Rather, the UE 406 may be centered between the first lateral side 126 and the second lateral side 128, in accordance with some embodiments. In some examples, the UE 406 may be considered to be centered between the first lateral side 126 and the second lateral side 128 when a centerline 410 (shown in FIG. 6A) of the UE 406 overlaps with a center point between the first lateral side 126 and the second lateral side 128. Alternatively and/or additionally, the UE 406 may be considered to be centered between the first lateral side 126 and the second lateral side 128 when the centerline 410 of the UE 406 is offset from the center point between the first lateral side 126 and the second lateral side 128 by a distance that is less than a second threshold distance. The second threshold distance may be less than about 4 centimeters. Alternatively and/or additionally, the second threshold distance may be about 3 centimeters, about 2 centimeters, about 1 centimeter, about 0.5 centimeters, about 0.2 centimeters, or about 0.1 centimeters. The centerline 410 of the UE 406 may correspond to a centerline between sides 412 and 414 of the UE 406.

At 504 of FIG. 5, the UE 406 may transform the distorted image 452 to a corrected image 462 based upon one or more positions of one or more landmarks on the landmark pad 402. For example, the one or more positions of the one or more landmarks may comprise coordinates, of the one or more landmarks, in the distorted image 452. FIG. 4E illustrates the corrected image 462 generated by the UE 406 based upon the distorted image 452, in accordance with some embodiments. In some examples, the UE 406 performs perspective transformation (or other suitable transformation technique) on the distorted image 452 to generate the corrected image 462. In some examples, the UE 406 may calculate, based upon the one or more landmarks on the landmark pad 402 (as depicted in the distorted image 452, for example), a transformation matrix mapping pixels of the distorted image 452 to the corrected image 462, and/or may apply the transformation matrix to the distorted image 452 to generate the corrected image 462. Alternatively and/or additionally, at least a portion of the distorted image 452 may be stretched, compressed, and/or rotated to generate the corrected image 462 (to remove warpage of the distorted image 452, for example). Alternatively and/or additionally, the UE 406 may perform depth illusion correction on the distorted image 452 to generate the corrected image 462.

In some examples, the distorted image 452 may comprise a video frame of a video (e.g., livestream video) captured using the rear-facing camera of the UE 406. The UE 406 may transform video frames of the video (which may be distorted and/or may comprise irregular quadrilateral representations of the landmark pad 402) to corrected video frames to generate a corrected video (comprising a rectangular representation of the landmark pad 402, for example), such as using one or more of the techniques provided herein with respect to transforming the distorted image 452 to the corrected image 462. For example, the corrected video may be generated in real-time (and/or in near real-time) as the video (e.g., distorted video) is being captured by the rear-facing camera.

In some examples, the UE 406 may determine the position and/or the size of the object 408 based upon the corrected image 462 and/or the corrected video. In some examples, the UE 406 may generate a virtual scene based upon the position and/or the size of the object 408 and/or display the virtual scene using the display of the UE 406. For example, the UE 406 may generate a graphical object based upon the position and/or the size of the object 408. In an example, the graphical object may comprise a representation of the object 408, which may be rendered in the virtual scene according to the determined position and/or size of the object 408.

In some examples, the UE 406 may determine (and/or detect) motion of the object 408 based upon the corrected video (by detecting displacement of the object 408 between two video frames of the corrected video, for example). Alternatively and/or additionally, the UE 406 may determine a velocity and/or an acceleration of the object 408 based upon the corrected video (based upon a distance by which the object 408 moves over time, for example). Embodiments are contemplated in which the motion, the velocity, and/or the acceleration of the object 408 are determined using a motion sensor and/or an accelerometer connected to the UE 406 and/or the object 408. Alternatively and/or additionally, the UE 406 may determine a shape of the object 408 based upon the corrected video (and/or based upon an image, such as the corrected image 462, generated using the rear-facing camera of the UE 406). In some examples, the UE 406 may generate the virtual scene and/or the graphical object (e.g., the representation of the object 408) based upon the (determined) velocity, the (determined) acceleration, and/or the (determined) shape of the object 408 (e.g., the representation of the object 408 may move through the virtual scene at a speed based upon the velocity and/or the acceleration and/or the representation of the object 408 may be rendered to resemble the shape). Alternatively and/or additionally, the UE 406 may output audio based upon the motion of the object 408, the velocity of the object 408, the acceleration of the object 408, and/or the shape of the object 408. For example, the audio may comprise speech indicating the motion, the velocity, the acceleration, and/or the shape.

In some examples, the UE 406 may capture a front-facing video using the front-facing camera 404. In some examples, the UE 406 may determine (and/or detect) motion of a second object based upon the front-facing video (by detecting displacement of the second object between two video frames of the front-facing video, for example). Alternatively and/or additionally, the UE 406 may determine a velocity and/or an acceleration of the second object based upon the front-facing video (based upon a distance by which the second object moves over time, for example). Embodiments are contemplated in which the motion, the velocity, and/or the acceleration of the second object are determined using a motion sensor and/or an accelerometer connected to the UE 406 and/or the second object. Alternatively and/or additionally, the UE 406 may determine a shape of the second object based upon the front-facing video (and/or based upon an image generated using the front-facing camera 404 of the UE 406). Alternatively and/or additionally, the UE 406 may determine an emotion of a user based upon the front-facing video (and/or based upon the image generated using the front-facing camera 404 of the UE 406), such as using an emotion recognition model. In some examples, the second object may comprise a token (and/or other physical object. Alternatively and/or additionally, the second object may comprise a feature of the user (e.g., a facial feature of the user and/or a hand of the user). In some examples, the UE 406 may generate the virtual scene and/or a second graphical object (e.g., a representation of the second object) based upon the (determined) velocity, the (determined) acceleration, and/or the (determined) shape of the second object (e.g., the second graphical object may move through the virtual scene at a speed based upon the velocity and/or the acceleration and/or the representation of the second object may be rendered to resemble the shape). Alternatively and/or additionally, the UE 406 may generate the virtual scene and/or the second graphical object based upon the emotion. For example, the speed and/or one or more visual characteristics of the second graphical object may be based upon the emotion. Alternatively and/or additionally, the UE 406 may output audio based upon the motion of the second object, the velocity of the second object, the acceleration of the second object, the shape of the second object, and/or the emotion. For example, the audio may comprise speech indicating the motion, the velocity, the acceleration, the shape, and/or the emotion. Alternatively and/or additionally, a tone and/or other characteristic of the speech may be modulated based upon the emotion.

FIGS. 6A-6E illustrate various scenarios in which the apparatus 100, the UE 406, and/or the system 400 is used to virtualize physical objects and/or interact with a user 602, in accordance with some embodiments. In some examples, the UE 406 and/or the apparatus 100 may be used to establish an interactive environment with the user 602. The interactive environment may combine physical component(s) (e.g., the apparatus 100, the landmark pad 402, and/or tokens 604) with digital component(s) (e.g., a mobile application executing on the UE 406) to create a unified mixed-reality system that enables real-time interaction between the user 602 and virtualized objects. For example, the UE 406 may execute an interactive application (as part of the interactive environment, for example). The interactive application may comprise an educational application (for the user 602 to learn language skills, mathematics, etc.), a cognitive development application (for improving memory, enhancing recall, improving motor skills, improving decision-making skills, etc.), an entertainment application, and/or one or more other types of applications.

The tokens 604 may comprise physical pieces (e.g., game and/or educational pieces) configured for use in interacting with the interactive environment. In some examples, the tokens 604 may have distinctive visual features and/or marker patterns detectable by the rear-facing camera of the UE 406 when positioned on and/or over the landmark pad 402 and/or detectable by the front-facing camera 404 when positioned in front of the front-facing camera 404. In some examples, the tokens 604 may comprise figurative and/or themed shapes (as elements of an educational and/or entertainment game, for example). One or more of the tokens 604 may be formed in the shape of a rocket, a spaceship, a cartoon character, and/or other shapes. In some examples, one or more of the tokens 604 may comprise flat or three dimensional tiles with one or more features including one or more colors, shapes (e.g., circles, squares, triangles, polygons, etc.), and/or textures that can be recognized individually and/or in groups to trigger various virtual responses. In some examples, the tokens 604 may comprise one or more dice, memory cards, blocks, toys, drawings, and/or other objects.

In some examples, the tokens 604 may include alphanumeric symbols, such as letters of an alphabet of a language (e.g., English, Persian, French, German, Arabic, Russian, etc.) and/or numerical digits. In some examples, a first group of the tokens 604 may comprise alphanumeric symbols of a first language (e.g., English) and/or a second group of the tokens 604 may comprise alphanumeric symbols of a second language (e.g., Persian). The first group of alphanumeric symbols may be used in a first educational mode to assist the user 602 in learning spelling, pronunciation, counting, and/or arithmetic in the first language. The second group of alphanumeric symbols may be used in a second educational mode to assist the user 602 in learning spelling, pronunciation, counting, and/or arithmetic in the second language. In some examples, the tokens 604 may be provided to the user 602 with the apparatus 100 (as part of a packaged kit and/or starter set, for example). Alternatively and/or additionally, at least some of the tokens 604 may comprise add-on tokens acquired separately from the packaged kit and/or the starter set (in an add-on kit, for example).

In some examples, the interactive application executed by the UE 406 may employ visual perception, auditory perception, and/or natural language processing to implement human-like engagement (with a personality, such as a robot-like personality, for example) with the user 602. In some examples, the interactive application may use a microphone of the UE 406 to record audio (e.g., speech and/or other noises made by the user 602) and/or may determine a transcript of the audio to use as input (e.g., the audio may be transcribed using a speech to text model to determine the transcript using artificial intelligence and/or other techniques). Alternatively and/or additionally, the interactive application may use a speaker of the UE 406 to output speech (e.g., speech synthesized by the interactive application using a text to speech model) and/or sound effects output by the interactive application. Alternatively and/or additionally, the interactive application may use a display to display an application interface. Alternatively and/or additionally, the interactive application may use the front-facing camera 404 of the UE 406 to identify one or more objects (e.g., the user 602 and/or one or more objects held by the user 602). Alternatively and/or additionally, the interactive application may use the rear-facing camera of the UE 406 to monitor a region under the UE stand 102 (e.g., the landmark pad 402 and/or one or more tokens positioned on or over the landmark pad 402).

In some examples, the interactive application may determine a user identity of the user 602 and/or associate the user 602 with a corresponding user profile based upon the user identity. For example, the interactive application may determine the user identity by performing facial recognition (e.g., real-time facial recognition) on an image and/or video captured using the front-facing camera 404 of the UE 406. Alternatively and/or additionally, the interactive application may determine the user identity by performing speech recognition on audio captured using the microphone of the UE 406. In some examples, the user profile of the user 602 may be indicative of an age, education level, settings, etc. associated with the user 602. The interactive application may adapt a session with the user 602 based upon the user profile. For example, the session may include asking one or more educational questions from the user 602 (by outputting the one or more educational questions using the speaker and/or the display of the UE 406), where a difficulty level of the one or more educational questions may be greater if the education level is greater.

In some examples, the interactive application may determine a user emotion of the user 602. For example, the interactive application may determine the user emotion (using an emotion recognition model, for example) by performing emotion detection (e.g., real-time emotion detection) on an image and/or video captured using the front-facing camera 404 of the UE 406, such as based upon facial landmarks of the user 602 and/or a facial expression exhibited by the user 602 in the image and/or the video. Alternatively and/or additionally, the interactive application may determine the user emotion based upon audio captured using the microphone of the UE 406, such as based upon a tone of voice exhibited by the user 602 in the audio. In some examples, the user emotion may be determined using an artificial intelligence model. The user emotion may indicate happiness, sadness, anger, surprise, nervousness, and/or other types of user emotion.

In some examples, the interactive application may execute a conversational session to converse with the user 602, for example, by outputting speech (e.g., synthesized speech) using the speaker, displaying a face 682 (shown in FIGS. 6D and 6E) using the display, recording audio using the microphone to identify speech and/or noises by the user 602, monitoring a video captured by the front-facing camera 404 to determine the user emotion of the user 602, and/or outputting one or more responses based upon the user speech and/or noises by the user 602 and/or the user emotion of the user 602. In some examples, a position of the user's face may be determined using the front-facing camera 404 (using a face detection and/or identification model, for example), and/or the interactive application may control eyes of the face 682 to look at the user's face and/or establish eye contact with the user 602 (which may thus enhance a sense of attention and/or presence). In some examples, the interactive application may synchronize mouth movements of the face 682 with the speech output using the speaker such that the face 682 appears to be talking with the user 602. In some examples, a facial expression of the user 602 may be determined (using the front-facing camera 404 of the UE 406, for example) and/or the face 682 may display a matching facial expression (to mimic the user 602, for example).

In an example of the conversational session, the interactive application may output a question (e.g., “What is the color of the sky?”) and/or a statement (e.g., “Name two things you learned in school today”). For example, the interactive application may output the question and/or the statement by synthesizing speech and/or outputting the speech via the speaker (while rendering mouth movements of the face 682 to be synchronized with the speech, for example). Alternatively and/or additionally, the interactive application may output the question and/or the statement by displaying the question and/or the statement on the display of the UE 406. In some examples, in response to outputting the question and/or the statement, the interactive application may monitor one or more inputs (e.g., the microphone, the front-facing camera 404 and/or the rear-facing camera) for a response of the user 602 to the question and/or the statement. In some examples, the response of the user 602 may be determined by detecting and/or transcribing speech of the user 602 recorded by the microphone. Alternatively and/or additionally, the response of the user 602 may be determined by analyzing an image and/or video captured by the rear-facing camera to identify one or more objects (e.g., one or more of the tokens 604) arranged to generate a response (e.g., the user 602 may arrange tokens with letters “B”, “L”, “U”, and “E” to respond to the question “What is the color of the sky?”). In some examples, the one or more objects may be identified using one or more object detection models. In some examples, in response to identifying the response of the user 602, the interactive application may respond to the user response, and/or may output a second question and/or a second statement, such as using one or more of the technique provided herein with respect to the interactive application outputting the question and/or the statement.

In some examples, the interactive application may adapt and/or control the conversational session based upon the user emotion of the user 602. For example, in response to detecting the user 602 having a negative emotion (e.g., nervousness, sadness, and/or anger), the interactive application may output one or more questions and/or statements associated with the negative emotion, such as a question asking why the user 602 has the negative emotion, a statement with an uplifting message and/or tone, etc. Alternatively and/or additionally, in response to detecting the user 602 having the negative emotion, the interactive application may control the conversational session to output less difficult questions and/or statements that require less effort to respond to. In an example in which the conversational session is used for teaching one or more topics (e.g., language, science, mathematics, etc.) to the user 602, the conversational session may be switched from a first difficulty level (in which relatively difficult topics are discussed and/or relatively difficult questions are asked of the user 602, for example) to a second difficulty level (in which less difficult topics are discussed and/or less difficult questions are asked of the user 602, for example).

In some examples, the interactive application may control the conversational session based upon user information associated with the user 602, which may be stored in the user profile of the user 602. In some examples, the user information may be indicative of historical behavior of the user 602, a name of the user 602, and/or one or more preferences of the user 602. For example, the interactive application may include the name of the user 602 in the conversational session and/or may adapt the conversational session to the preferences and/or the historical behavior of the user 602 to provide a personalized user experience. In some examples, in response to opening the interactive application and/or starting the conversational session, the interactive application may greet the user 602 by name (e.g., “Hi Greg”).

In some examples, the interactive application may monitor for and/or detect a command by the user 602, and/or may respond to the command. In an example, the command may be received via the microphone by the user 602 stating “Show me pictures of my friends”, and/or the interactive application may respond to the command by displaying one or more pictures of one or more friends of the user 602 (e.g., the one or more pictures may be retrieved from memory of the UE 406 and/or a cloud) and/or outputting (via the speaker, for example) names of the one or more friends.

FIG. 6A illustrates the interactive application executing a galaxy exploration game, in accordance with some embodiments. For example, the interactive application may determine a position of a token 606 (e.g., a spaceship token) of the tokens 604 using the rear-facing camera of the UE 406. For example, the position of the token 606 may be determined by capturing an image using the rear-facing camera of the UE 406 and/or comparing the position of the token 606 with one or more landmarks on the landmark pad 402. In some examples, the position of the token 606 may be mapped to a position on the display of the UE 406, and/or a spaceship graphical object (and/or other type of graphical object) may be rendered at the position on the display. In some examples, the position of the token 606 may be monitored and/or the spaceship graphical object may be adjusted based upon a change to the position of the token 606. In some examples, a goal of the galaxy exploration game may be maneuvering the spaceship graphical object around one or more obstacles and/or defeating one or more enemy objects. The galaxy exploration game may develop coordination of the user 602 while mitigating negative screen-time effects on the user 602.

FIG. 6B illustrates the interactive application executing a mathematics game, in accordance with some embodiments. For example, the mathematics game may be used to teach the user 602 numbers and/or mathematical concepts (e.g., addition, subtraction, multiplication, division, etc.). For example, the mathematics game may display a problem (e.g., “3+9=?”) and/or may monitor for a user response to the problem. In some examples, the interactive application may monitor one or more inputs (e.g., the microphone, the front-facing camera 404 and/or the rear-facing camera) for the response to the problem. In some examples, the response of the user 602 may be determined by detecting and/or transcribing speech of the user 602 recorded by the microphone. Alternatively and/or additionally, the response of the user 602 may be determined by analyzing an image and/or video captured by the rear-facing camera to identify objects 608 arranged to generate the response (e.g., the objects 608 may comprise tokens “1” and “2” arranged to indicate 12 in response to the problem). In some examples, the objects 608 may be identified using one or more object detection models. In some examples, in response to identifying the response of the user 602, the interactive application may provide feedback indicating whether the response is correct or incorrect, and/or may provide a correct answer or a hint in response to the response being incorrect.

FIG. 6C illustrates the interactive application executing a spelling game, in accordance with some embodiments. For example, the mathematics game may be used to teach the user 602 spelling, animal sounds and/or characteristics, pronunciation, and/or other concepts. For example, the mathematics game may display a prompt (e.g., “Meow Meow”) and/or output a sound effect (e.g., a sound indicative of a cat) and/or may monitor for a user response to the prompt. In some examples, the interactive application may monitor one or more inputs (e.g., the microphone, the front-facing camera 404 and/or the rear-facing camera) for the response to the prompt. In some examples, the response of the user 602 may be determined by detecting and/or transcribing speech of the user 602 recorded by the microphone. Alternatively and/or additionally, the response of the user 602 may be determined by analyzing an image and/or video captured by the rear-facing camera to identify objects 610 arranged to generate the response (e.g., the objects 610 may comprise tokens “C”, “A”, and “T” arranged to indicate CAT in response to the prompt). In some examples, the objects 610 may be identified using one or more object detection models. In some examples, in response to identifying the response of the user 602, the interactive application may provide feedback indicating whether the response is correct or incorrect, and/or may provide a correct answer or a hint in response to the response being incorrect.

In some examples, the interactive application may execute a memory game. The memory game may be used to enhance the cognitive memory and/or recognition abilities of the user 602. In some examples, in the memory game, the interactive application may display one or more visual elements (e.g., with one or more shapes, symbols, colors, and/or characters) for a predefined duration of time, after which the visual elements may disappear from the display. The application interactive may then monitor for a user response corresponding to the previously displayed elements. In some examples, the interactive application may monitor one or more inputs (e.g., the microphone, the front-facing camera 404, and/or the rear-facing camera) to detect the response of the user 602. In some examples, the response may be determined by analyzing an image and/or video captured by the rear-facing camera to identify one or more objects arranged to represent the remembered shapes (e.g., the one or more objects may comprise tokens corresponding to the shapes or symbols previously displayed on the screen). In some examples, the one or more objects may be identified using one or more object detection models. In some examples, in response to identifying the response of the user 602, the interactive application may provide feedback indicating whether the response is correct or incorrect, and/or may display the correct sequence of shapes or provide a hint in response to the response being incorrect.

In some examples, the interactive application may execute a household object game. The household object game may be used to teach the user 602 identification, naming, and/or understanding of household items. In some examples, the interactive application may instruct the user 602 to move the apparatus 100 and/or the UE 406 throughout a room and/or home environment and to present various objects within the field of view of the front-facing camera 404 and/or the rear-view camera. In some examples, the interactive application may monitor a captured image and/or video of the front-facing camera 404 and/or the rear-facing camera to detect the presence of an object within the captured image and/or video. In some examples, the objects 610 may be identified by the interactive application using one or more object detection models trained to recognize common household items (e.g., a chair, table, lamp, book, etc.). In response to identifying an object, the application may provide an audible and/or visual output indicating the object's name, spelling, and/or functional description (e.g., “This is a chair—C-H-A-I-R—it is used for sitting”). In some examples, the interactive application may further prompt the user 602 to repeat the name of the object, spell the object's name, and/or describe its function aloud. In some examples, speech input from the user 602 may be received and analyzed by the microphone and/or processed using one or more speech-to-text models. In some examples, based upon the detected response, the application may provide corresponding feedback, reinforcement, and/or additional information to enhance engagement and learning.

In some examples, the interactive application may adapt and/or control a game (e.g., the galaxy exploration game, the mathematics game, the spelling game, the memory game, the household object game, and/or other game) based upon the user emotion of the user 602. For example, in response to detecting the user 602 having a negative emotion (e.g., nervousness, sadness, and/or anger), the interactive application may decrease a difficulty level of the game, or may pause the game and/or initiate a conversation session with the user 602.

In some examples, the user profile of the user 602 may be indicative of an age, education level, settings, etc. associated with the user 602. The interactive application may control a session (e.g., a conversational session and/or a game) based upon the user profile. For example, a difficulty level of the session may be greater if the education level is greater (e.g., by increasing a difficulty of one or more educational questions asked of the user 602 in the session, for example).

FIGS. 6D and 6E illustrates the interactive application executing a conversational session, in accordance with some embodiments. For example, in response to determining that the user emotion of the user 602 is happy, the interactive application may output (via the speaker, for example) a statement 672 (shown in FIG. 6D) saying that the user 602 seems happy, and/or may instruct the user 602 to ask a question. The user 602 may respond to the statement 672 by asking a question 674 (shown in FIG. 6E), for example, “What's my cat's name?”. In some examples, in response to the question 674 the interactive application may determine, based upon the user profile of the user 602, a name of a pet cat of the user 602, and/or may output the name (via the speaker, for example) of the cat and/or display a stored picture of the cat. In some examples, in response to determining that the user emotion of the user 602 is sad and/or angry, the interactive application may display a graphical object (e.g., a video and/or animation) with tips on managing sadness and/or anger.

In some examples, the interactive application may execute an online learning framework. For example, the online learning framework may be used to enable real-time remote instruction and/or interaction between a teacher and one or more users, such as the user 602. In some examples, the interactive application may establish a live communication session between the UE 406 and a remote instructor through a network connection. In some examples, the interactive application may activate the front-facing camera 404 and/or the rear-facing camera of the UE 406. The front-facing camera 404 may capture the face and/or facial expressions of the user 602, while the rear-facing camera may capture a workspace area (e.g., the user's hands, notebook, physical tokens, and/or other materials) in a region under and/or in front of the apparatus 100 holding the UE 406. In some examples, the front-facing camera 404 and the rear-facing camera of the UE 406 may be activated concurrently such that the remote instructor is provided with real-time visual feeds of the face of the user 602 and the workspace area. In some examples, the captured visual feeds may be transmitted to the instructor in real time, allowing the instructor to monitor the learning environment, observe user engagement, and/or provide immediate guidance or feedback. In some examples, the interactive application may display a live video feed of the instructor and/or instructional content (e.g., written notes, diagrams, and/or digital teaching materials) on the display of the UE 406. In some examples, audio communication may be established bi-directionally, such that the instructor and the user 602 may speak and/or listen through the microphone and/or speakers of the UE 406. In some examples, the interactive application may employ one or more AI-based models (e.g., facial recognition, emotion detection, and/or speech-to-text) to monitor user focus, responsiveness, and/or participation. In some examples, the interactive application may provide adaptive prompts and/or recommendations to maintain engagement and/or facilitate an effective remote educational experience.

In some examples, the online learning framework may be utilized to administer assessments such as examinations and/or other testing activities. Alternatively and/or additionally, the online learning framework may be utilized to ensure academic integrity during the assessments. In some examples, the interactive application may activate both the front-facing camera 404 and the rear-facing camera of the UE 406 to concurrently capture the user 602 and the workspace area during an assessment session. The front-facing camera 404 may be used to monitor a facial orientation, a gaze direction, and/or one or more expressions of the user 602 to verify attention and/or to detect irregular behaviors indicative of potential cheating (e.g., looking away from the display for extended periods, speaking to another person, or using unauthorized materials). In some examples, the interactive application may provide an alert to an instructor and/or proctor in response to detecting an irregular behavior. The rear-facing camera may capture the workspace, which may include the user's hands, desk, and/or testing materials. A feed from the rear-facing camera may be monitored to detect presence of an unpermitted object. In some examples, the interactive application may provide an alert to the instructor and/or proctor in response to detecting an unpermitted object. In some examples, one or more AI-based models, such as face recognition, object detection, and/or activity classification models, may be employed to automatically analyze visual feeds from the front-facing camera 404 and/or the rear-facing camera and/or an audio feed from the microphone in real time to detect irregular behaviors and/or unpermitted objects. For example, the microphone may be used to monitor for background speech and/or other sounds inconsistent with normal testing conditions. In some examples, captured data (e.g., video and/or audio logs) may be transmitted (e.g., securely transmitted over a secure network) to and/or stored on a remote server for review by the instructor or proctor. Accordingly, the online learning framework may provide a secure and/or monitored assessment environment that supports remote testing and/or automated cheating detection (while maintaining interactive and/or educational capabilities, for example).

Embodiments are contemplated in which the apparatus 100 and/or the interactive application executed by the UE 406 is used by a plurality of users (in a multiplayer mode, for example). For example, the user 602 may be in front of the apparatus 100 and/or the UE 406 (such as shown in FIGS. 6A-6E) while a second user is behind the apparatus 100. In some examples, the set of legs being coupled to lateral sides of the UE stand 102 may enable (both) the user 602 and the second user to reach a region under the UE stand 102 (and/or over and/or on the landmark pad 402) without being obstructed, such that the user 602 and the second user can concurrently interact with the interactive application executed by the UE 406. In some examples, a board game may be placed under and/or in front of the UE stand 102 of the apparatus 100, and/or the UE 406 may display a representation of the board game.

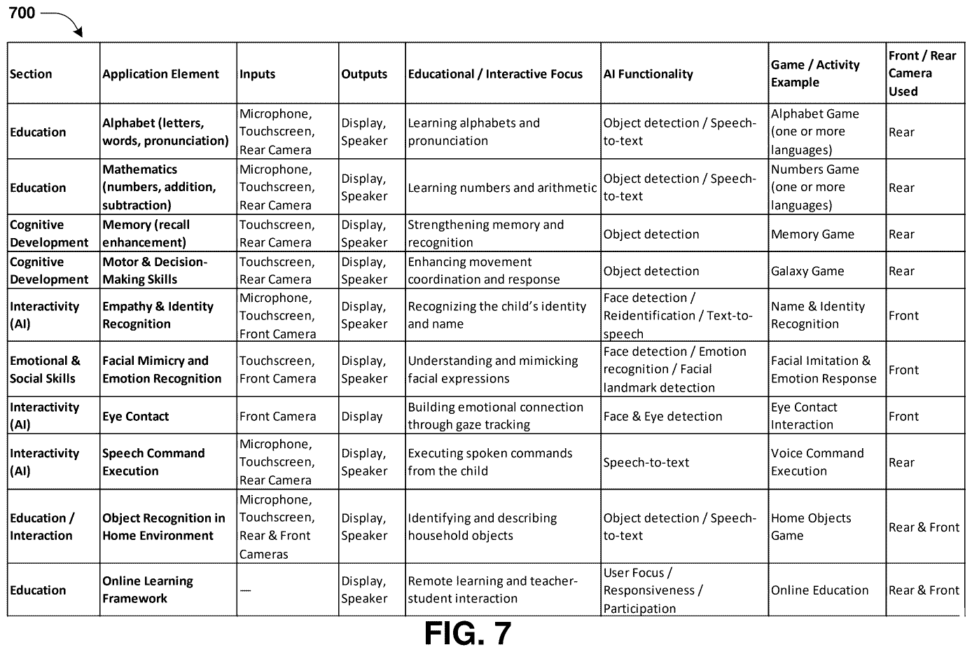

FIG. 7 illustrates a data structure 700 indicative of exemplary features of various exemplary application elements executed by the interactive application, in accordance with some embodiments. In some examples, some and/or all of the application elements may be executed concurrently and/or at separate times.

In some examples, at least some of the disclosed subject matter may be implemented on a UE. In some examples, at least some of the disclosed subject matter may be implemented on a server (e.g., hosting a service accessible via a network, such as the Internet).

In some examples, an apparatus is provided. The apparatus includes a UE stand including (i) a front surface and a back surface, (ii) a mirror between the front surface and the back surface and exposed by a first opening defined in the front surface, and (iii) a set of support structures configured to support a UE in a target position adjacent the front surface. In some examples, the mirror is tilted at a first angle relative to a vertical axis and a second angle relative to a lateral axis to redirect a field of view of a camera of the UE to a region under the UE stand. In some examples, the vertical axis extends through a top side and a bottom side of the UE stand. In some examples, the lateral axis extends through a first lateral side and a second lateral side of the UE stand.

In some examples, the set of support structures includes (i) a first support structure protruding from the front surface, wherein the first support structure is proximal the top side and distal the bottom side and is configured to engage a first side of the UE, and (ii) a second support structure protruding from the front surface, wherein the second support structure is proximal the bottom side and distal the top side and is configured to engage at least one of a second side of the UE or an adaptor.

In some examples, the first support structure protrudes through a second opening defined in the front surface and is moveable between a first position relative to the second opening and a second position relative to the second opening. In some examples, the first position is closer to the top side of the UE stand than the second position.

In some examples, the apparatus includes a biasing component configured to bias the first support structure toward the second position.

In some examples, the apparatus includes a set of detachable adaptors mountable to the second support structure and configured to engage the second side of the UE to support the UE in the target position.

In some examples, the apparatus includes a set of legs configured to support the UE stand over a support surface, wherein each leg of the set of legs comprises a first side pivotally coupled to the UE stand and a second side configured to engage the support surface.

In some examples, the set of legs includes (i) a first leg pivotally coupled to the first lateral side of the UE stand, and (ii) a second leg pivotally coupled to the second lateral side of the UE stand. In some examples, the region to which the field of view of the camera of the UE is redirected comprises a region between the first leg and the second leg.

In some examples, the first angle is between about 20 degrees to about 45 degrees.

In some examples, the second angle is between about 3 degrees to about 15 degrees.

In some examples, the camera is a rear-facing camera of the UE. In some examples, the UE is centered between the first lateral side of the UE stand and the second lateral side of the UE stand.

In some examples, a system is provided. The system includes (i) a landmark pad including a set of landmarks, and (ii) an apparatus to support a User Equipment (UE). In some examples, the apparatus includes a UE stand including (i) a front surface, (ii) a back surface, (iii) a mirror between the front surface and the back surface and exposed by a first opening defined in the front surface, and (iv) a set of support structures configured to support a UE in a target position adjacent the front surface, wherein the mirror is oriented to redirect a field of view of a camera of the UE to the landmark pad positioned under the UE stand.

In some examples, the apparatus of the system includes a set of legs, configured to support the UE stand over the landmark pad. In some examples, the set of legs includes (i) a first leg pivotally coupled to a first lateral side of the UE stand, and (ii) a second leg pivotally coupled to the second lateral side, of the UE stand, opposite the first lateral side of the UE stand.

In some examples, the landmark pad defines a first groove in a first edge of the landmark pad and a second groove in a second edge of the landmark pad. In some examples, the first leg includes (i) a first side pivotally coupled to the UE stand and a second side configured to engage at least one of the landmark pad or a support surface on which the landmark pad is positioned, and (ii) a first protrusion, proximal the second side and distal the first side, configured to engage the first groove. In some examples, the second leg includes (i) a first side pivotally coupled to the UE stand and a second side configured to engage at least one of the landmark pad or the support surface, and (ii) a second protrusion, proximal the second side of the second leg and distal the first side of the second leg, configured to engage the second groove.

In some examples, the UE is configured to (i) use the camera to capture a distorted image comprising an irregular quadrilateral representation of the landmark pad, and (ii) transform, based upon one or more positions of one or more landmarks of the set of landmarks, the distorted image to a corrected image comprising a rectangular representation of the landmark pad.

In some examples, the camera of the UE of the system is a rear-facing camera of the UE.

In some examples, in the system, the mirror is tilted at a first angle relative to a vertical axis and a second angle relative to a lateral axis. In some examples, in the system, the vertical axis extends through a top side and a bottom side of the UE stand. In some examples, in the system, the lateral axis extends through a first lateral side and a second lateral side of the UE stand.

In some examples, a method for a UE supported in a target position by an apparatus is provided. The method includes (i) capturing, using the rear-facing camera, a distorted image comprising an irregular quadrilateral representation of the landmark pad, and (ii) transforming, based upon one or more positions of one or more landmarks on the landmark pad, the distorted image to a corrected image comprising a rectangular representation of the landmark pad. In some examples, the apparatus in the method includes a UE stand including (i) a front surface, (ii) a back surface, (iii) a mirror between the front surface and the back surface and exposed by a first opening defined in the front surface, and (iv) a set of support structures configured to support the UE in the target position adjacent the front surface, wherein the mirror is oriented to redirect a field of view of a rear-facing camera of the UE to a landmark pad positioned under the UE stand.

In some examples, the method includes (i) capturing, using a front-facing camera of the UE, a video, (ii) determining at least one of an emotion of a user in the video, motion of a physical object in the video, a velocity of the physical object, an acceleration of the physical object, or a shape of the physical object, based upon the video, and (iii) at least one of (a) displaying a graphical object based upon at least one of the emotion, the motion, the velocity, the acceleration, or the shape, or (b) outputting audio based upon at least one of the emotion, the motion, the velocity, the acceleration, or the shape.

In some examples, the method includes (i) capturing, using the rear-facing camera, a distorted video, (ii) transforming the distorted video to a corrected video comprising a rectangular representation of the landmark pad, (iii) determining, based upon the corrected video, at least one of motion of a second physical object in the corrected video, a velocity of the second physical object, an acceleration of the second physical object, or a shape of the physical object, and (iv) at least one of (a) displaying a second graphical object based upon at least one of the motion, the velocity, the acceleration, or the shape, or (b) outputting audio based upon at least one of the motion, the velocity, the acceleration, or the shape.

In some examples, in the method, the mirror is tilted at a first angle relative to a vertical axis and a second angle relative to a lateral axis. In some examples, in the method, the vertical axis extends through a top side and a bottom side of the UE stand. In some examples, in the method, the lateral axis extends through a first lateral side and a second lateral side of the UE stand.

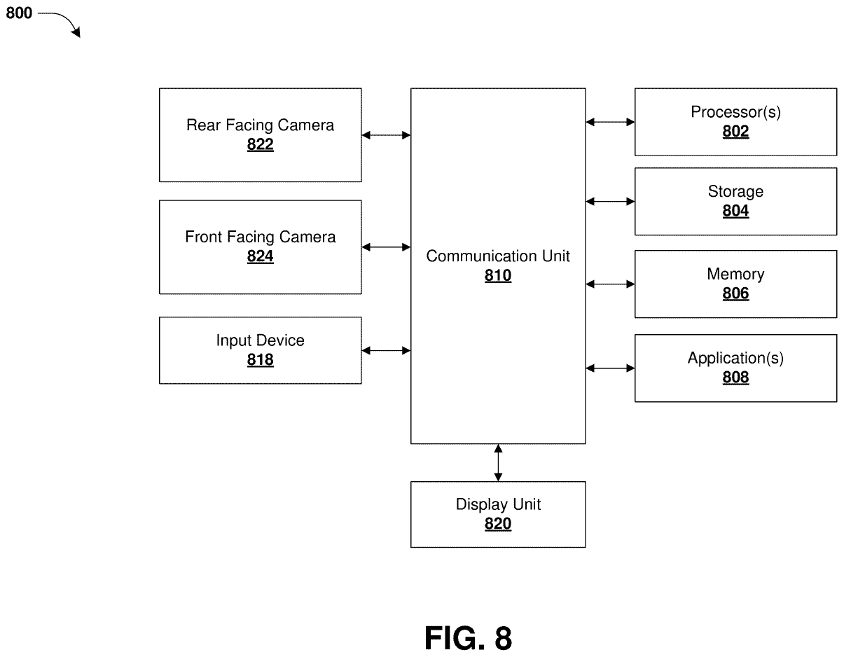

FIG. 8 illustrates a block diagram of an exemplary UE 800, in accordance with one or more exemplary embodiments of the present disclosure. For example, the UE 800 may comprise the first UE 202, the second UE 302, and/or the UE 406. UE 800 may comprise processor(s) 802, memory 806, rear-facing camera 822 (e.g., the rear-facing camera 208 of the first UE 202, the rear-facing camera 308 of the second UE 302, and/or the rear-facing camera of the UE 406), front-facing camera 824 (e.g., the front-facing camera 204 of the first UE 202, the front-facing camera 304 of the second UE 302, and/or the front-facing camera 404 of the UE 406), input device 818, and/or display unit 820, which may communicate with each other using a communication unit 810. In some exemplary embodiments, UE 800 may comprise processor(s) 802 to detect and determine at least one characteristic of physical objects in a video stream captured with rear-facing camera 822 of UE 800. The processor(s) 802 may produce a virtual scene according to at least one characteristic of physical objects, and/or may display the virtual scene in display unit 820 of UE 800. Processor(s) 802 may comprise one or more processing units and/or cores which may implement application(s) 808 by employing artificial intelligence algorithms comprise deep learning methods. In some exemplary embodiments, application(s) 808 may comprise a math game, an alphabet game, cognitive functions such as, but not limited to, working memory, problem solving, decision making, and/or critical thinking tasks, common smart phone games, and/or various animations. The math game may be a self-paced, curriculum-inspired series which may combine hands-on learning with digital adventure. The alphabet game may include plenty of words to help user to learn/improve vocabulary with correct phonetics and writings. Working memory application may include any memory card game which help user to memorize and remember physical objects. Application(s) 808 may be executed with various languages.

Memory 806 is a medium which may be used to store data for UE 800. Memory 806 may comprise various types of SIM memory, Read Only Memory (ROM), Random Access Memory (RAM), internal memory, and/or external memory. Memory 806 may be connected to communication unit 810 to share stored data with other components of UE 800. Components of UE 800 may communicate through communication unit 810 by a wired and/or wireless network like Near Field Communication (NFC), Local Area Network (LAN), Wide Area Network (WAN), Bluetooth, and/or any similar network.

In some exemplary embodiments, storage 804 may be connected with processor(s) 802 retrieve and/or manipulate data stored therein. Storage 804 may be a data storage system and/or a cloud-based computing system. In some exemplary embodiments, storage 804 may include database management system (DBMS) which may be used in execution of algorithms of application(s) 808.

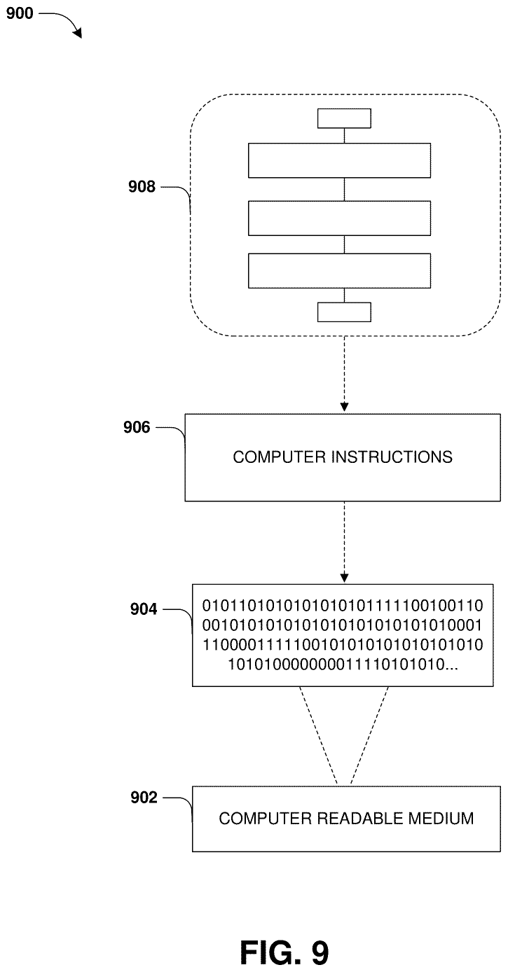

Another embodiment involves a computer-readable medium comprising processor-executable instructions. The processor-executable instructions may be configured to implement one or more of the techniques presented herein. An exemplary computer-readable medium that may be devised in these ways is illustrated in FIG. 9. An implementation 900 may comprise a computer-readable medium 902 (e.g., a CD, DVD, or at least a portion of a hard disk drive), which may comprise encoded computer-readable data 904. The computer-readable data 904 comprises a set of computer instructions 906 configured to operate according to one or more of the principles set forth herein. In one such embodiment 900, the processor-executable computer instructions 906 may be configured to perform a method 908, such as at least some of the example method 500 of FIG. 5, for example. Many such computer-readable media 902 may be devised by those of ordinary skill in the art that are configured to operate in accordance with the techniques presented herein.

Various operations of embodiments are provided herein. In one embodiment, one or more of the operations described may comprise computer readable instructions stored on one or more computer readable media, which if executed by a computing device, will cause the computing device to perform the operations described. The order in which some or all of the operations are described should not be construed as to imply that these operations are order dependent. Alternative ordering will be appreciated by one skilled in the art having the benefit of this description. Further, it will be understood that not all operations are present in each embodiment provided herein.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

As used in this application, the terms “system”, “component,” “interface”, “module,” and the like are generally intended to refer to a computer-related entity, either hardware, software, a combination of hardware and software, or software in execution. For example, a component may be, but is not limited to being, an object, a process running on a processor, a processor, a program, an executable, a thread of execution, and/or a computer. By way of illustration, an application running on a controller and the controller can be a component. One or more components may reside within a thread of execution and/or process and a component may be distributed between two or more computers and/or localized on one computer.

Furthermore, the claimed subject matter may be implemented as an apparatus, method, and/or article of manufacture using standard programming and/or engineering techniques to produce hardware, firmware, software, or any combination thereof to control a computer that may implement the disclosed subject matter. The term “article of manufacture” as used herein is intended to encompass a computer program (e.g., accessible from any computer-readable device, carrier, or media). Of course, those skilled in the art will recognize many modifications may be made to this configuration without departing from the scope or spirit of the claimed subject matter.

Moreover, the word “exemplary” is used herein to mean serving as an example, illustration, or instance. Any design or aspect described herein as “exemplary” is not necessarily to be construed as advantageous over other designs or aspects. Rather, use of the word “exemplary” is intended to present concepts in a concrete fashion. As used in this application, the word “or” is intended to mean an inclusive “or” (e.g., rather than an exclusive “or”). That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the words “a” and “an” as used in this application and the appended claims may generally be construed to mean “one or more” (e.g., unless specified otherwise or clear from context to be directed to a singular form). Also, at least one of A or B or the like generally means A or B or both A and B. Furthermore, to the extent that the terms “includes”, “having”, “has”, “with”, or variants thereof are used in either the detailed description or the claims, such terms are intended to be inclusive in a manner similar to the term “comprising.”

Although the disclosure has been shown and described with respect to one or more implementations, modifications and alterations will occur to others skilled in the art based (e.g., at least in part) upon a reading of this specification and the annexed drawings. The disclosure includes all such modifications and alterations. The disclosure is limited only by the scope of the following claims. In regard to the various functions performed by the above described components (e.g., resources, elements, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. Additionally, while a particular feature of the disclosure may have been disclosed with respect to only one of several implementations, the particular feature may be combined with one or more other features of the other implementations as may be desired and/or advantageous for any given or particular application.

What is claimed is:

1. An apparatus, comprising:
a User Equipment (UE) stand comprising:
a front surface and a back surface;
a mirror between the front surface and the back surface and exposed by a first opening defined in the front surface; and
a set of support structures configured to support a UE in a target position adjacent the front surface, wherein:
the mirror is tilted at a first angle relative to a vertical axis and a second angle relative to a lateral axis to redirect a field of view of a camera of the UE to a region under the UE stand;
the vertical axis extends through a top side and a bottom side of the UE stand; and
the lateral axis extends through a first lateral side and a second lateral side of the UE stand.

2. The apparatus of claim 1, wherein the set of support structures comprises:
a first support structure protruding from the front surface, wherein the first support structure is proximal the top side and distal the bottom side and is configured to engage a first side of the UE; and
a second support structure protruding from the front surface, wherein the second support structure is proximal the bottom side and distal the top side and is configured to engage at least one of a second side of the UE or an adaptor.

3. The apparatus of claim 2, wherein:
the first support structure protrudes through a second opening defined in the front surface and is moveable between a first position relative to the second opening and a second position relative to the second opening; and
the first position is closer to the top side of the UE stand than the second position.

4. The apparatus of claim 3, comprising:
a biasing component configured to bias the first support structure toward the second position.

5. The apparatus of claim 2, comprising:
a set of detachable adaptors mountable to the second support structure and configured to engage the second side of the UE to support the UE in the target position.

6. The apparatus of claim 1, comprising:
a set of legs configured to support the UE stand over a support surface, wherein each leg of the set of legs comprises a first side pivotally coupled to the UE stand and a second side configured to engage the support surface.

7. The apparatus of claim 6, wherein:
the set of legs comprises:
a first leg pivotally coupled to the first lateral side of the UE stand; and
a second leg pivotally coupled to the second lateral side of the UE stand; and
the region to which the field of view of the camera of the UE is redirected comprises a region between the first leg and the second leg.

8. The apparatus of claim 1, wherein:
the first angle is between about 20 degrees to about 45 degrees.

9. The apparatus of claim 1, wherein:
the second angle is between about 3 degrees to about 15 degrees.

10. The apparatus of claim 1, wherein:
the camera is a rear-facing camera of the UE; and
the UE is centered between the first lateral side of the UE stand and the second lateral side of the UE stand.

11. A system, comprising:
a landmark pad comprising a set of landmarks; and
an apparatus to support a User Equipment (UE), the apparatus comprising:
a UE stand comprising:
a front surface;
a back surface;
a mirror between the front surface and the back surface and exposed by a first opening defined in the front surface; and
a set of support structures configured to support a UE in a target position adjacent the front surface, wherein the mirror is oriented to redirect a field of view of a camera of the UE to the landmark pad positioned under the UE stand.

12. The system of claim 11, wherein the apparatus comprises:
a set of legs, configured to support the UE stand over the landmark pad, comprising:
a first leg pivotally coupled to a first lateral side of the UE stand; and
a second leg pivotally coupled to the second lateral side, of the UE stand, opposite the first lateral side of the UE stand.

13. The system of claim 12, wherein:
the landmark pad defines a first groove in a first edge of the landmark pad and a second groove in a second edge of the landmark pad;
the first leg comprises:
a first side pivotally coupled to the UE stand and a second side configured to engage at least one of the landmark pad or a support surface on which the landmark pad is positioned; and
a first protrusion, proximal the second side and distal the first side, configured to engage the first groove; and
the second leg comprises:
a first side pivotally coupled to the UE stand and a second side configured to engage at least one of the landmark pad or the support surface; and
a second protrusion, proximal the second side of the second leg and distal the first side of the second leg, configured to engage the second groove.

14. The system of claim 11, wherein:
the UE is configured to:
use the camera to capture a distorted image comprising an irregular quadrilateral representation of the landmark pad; and
transform, based upon one or more positions of one or more landmarks of the set of landmarks, the distorted image to a corrected image comprising a rectangular representation of the landmark pad.

15. The system of claim 14, wherein:
the camera is a rear-facing camera of the UE.

16. The system of claim 11, wherein:
the mirror is tilted at a first angle relative to a vertical axis and a second angle relative to a lateral axis;
the vertical axis extends through a top side and a bottom side of the UE stand; and
the lateral axis extends through a first lateral side and a second lateral side of the UE stand.

17. A method for a User Equipment (UE) supported in a target position by an apparatus,
the apparatus comprising:
a UE stand comprising:
a front surface;
a back surface;
a mirror between the front surface and the back surface and exposed by a first opening defined in the front surface; and
a set of support structures configured to support the UE in the target position adjacent the front surface, wherein the mirror is oriented to redirect a field of view of a rear-facing camera of the UE to a landmark pad positioned under the UE stand,
the method comprising:
capturing, using the rear-facing camera, a distorted image comprising an irregular quadrilateral representation of the landmark pad; and
transforming, based upon one or more positions of one or more landmarks on the landmark pad, the distorted image to a corrected image comprising a rectangular representation of the landmark pad.

18. The method of claim 17, comprising:
capturing, using a front-facing camera of the UE, a video;
determining at least one of an emotion of a user in the video, motion of a physical object in the video, a velocity of the physical object, an acceleration of the physical object, or a shape of the physical object, based upon the video; and
at least one of:
displaying a graphical object based upon at least one of the emotion, the motion, the velocity, the acceleration, or the shape; or
outputting audio based upon at least one of the emotion, the motion, the velocity, the acceleration, or the shape.

19. The method of claim 17, comprising:
capturing, using the rear-facing camera, a distorted video;
transforming the distorted video to a corrected video comprising a rectangular representation of the landmark pad;
determining, based upon the corrected video, at least one of motion of a second physical object in the corrected video, a velocity of the second physical object, an acceleration of the second physical object, or a shape of the physical object; and
at least one of:
displaying a second graphical object based upon at least one of the motion, the velocity, the acceleration, or the shape; or
outputting audio based upon at least one of the motion, the velocity, the acceleration, or the shape.

20. The method of claim 17, wherein:
the mirror is tilted at a first angle relative to a vertical axis and a second angle relative to a lateral axis;
the vertical axis extends through a top side and a bottom side of the UE stand; and
the lateral axis extends through a first lateral side and a second lateral side of the UE stand.
